(19) United States
(12) Patent Application Publication
(10) Pub. No.: US 2002/0017537 A1
(43) Pub. Date: Feb. 14, 2002

(54) Conveyor/sorter system, a loading conveyor and a control system for such conveyors

(76) Inventors: Per Barklin, Arhus N (DK); Henrik Andersen, Hornslet (DK); Ralph Kofoed, Hornslet (DK); Ole Prydtz, Ronde (DK); Thomas Moldt Jacobsen, Hornslet (DK); Svend E. Farso Bomholt, Silkeborg (DK); Hans Stensgard-Bay, Abyhoj (DK); Ivan Kristensen, Finderup (DK); Per Nielsen, Solbjerg (DK); Finn Lyng Pedersen, Lystrup (DK); Dennis Sorensen, Hammel (DK); Poul M. Eriksen, Arhus V (DK)

Correspondence Address: BIRCH STEWART KOLASCH & BIRCH, PO BOX 747, FALLS CHURCH, VA, 22040-0747, US

(21) Appl. No.: 09/870,700

(22) Filed: Jun. 1, 2001

Related U.S. Application Data
(63) Continuation of application No. PCT/DK99/00673, filed on Dec. 1, 1999.
(60) Provisional application No. 60/148,564, filed on Aug. 13, 1999.

(30) Foreign Application Priority Data
Dec. 1, 1998 (DK) PA1998 01584
Jul. 2, 1999 (DK) PA 1999 00960
Aug. 24, 1999 (DK) PA 1999 01174

(51) Int. Cl. G01F 11/00

(52) U.S. Cl. 222/240; 222/227

(57) ABSTRACT

A conveyor system for sorting articles comprises a plurality of conveyor units adapted to run along a conveyor path having vertical and/or horizontal loops. The conveyor system comprises loading conveyors for loading articles onto the conveyor units, and wherein each or some of the loading conveyors and/or conveyor units comprise barrier means for stopping the displacement of an article in relation to the loading conveyor and/or conveyor units. The loading conveyor may be adapted to reorient or rotate an article during loading and to load an article having a length greater than the length of a single conveyor unit onto two or more contiguous conveyor units. The loading conveyor may load at least two articles onto one conveyor unit, so that the articles are arranged next to each other on the conveyor unit. The conveyor system comprises a control system for controlling, according to predetermined velocity ramps, the driving means for loading and unloading articles. The conveyor system may have means for utilization of the interstices between the conveyor units in the conveyor system. In particular, but not solely, the conveyor system comprises conveyors having cross-belts for loading and unloading articles in a direction transverse to the transport direction of the conveyor.

### TECHNICAL FIELD

The present invention relates to conveyor systems for conveying and/or sorting articles, such as piece goods, postal articles, packages etc. The invention further relates to loading conveyors or systems for a conveyor system, conveyor units for use in conveyor systems, methods of operating conveyor systems and methods of loading and unloading articles to/from conveyor systems. In particular, but not solely, the present invention is concerned with cross-belt conveyors.

### BACKGROUND OF THE INVENTION

Generally, conveyors of the type relevant to the present invention are adapted to run along a conveyor path which is usually made up of an endless loop of tracks in either a vertical or a horizontal plane. Recently, in WO 99/35064, a conveyor capable of running in vertical and horizontal planes has been proposed. Various kinds of driving means have been proposed for such conveyors, the most commonly used driving means comprising chain drives or linear induction motor drives. The conveyors comprise load supporting surfaces, such as, e.g., tilt trays each of which is adapted to be tilted, so as to unload an article being carried by a tray, or cross-belts adapted to run transversely, usually perpendicularly, to the direction of travel of the conveyor, so as to thereby load and unload articles by movement of the cross-belt. A further type of conveyors is the so-called pusher type conveyors, in which articles are supported by passive, non-tiltable load supporting surfaces, wherein moveable pushers are provided in interstices between the supporting surfaces. When an article is to be unloaded, the pushers are moved perpendicularly to the direction of travel of the conveyor, and by engagement of the pushers with a side portion of an article, that article may be discharged at an unloading station. Any of the above-mentioned types of prior art conveyors comprise at least one, and normally a plurality of loading stations at which articles, such as postal packages, mail bags, department store articles, airport luggage, etc., are loaded onto supporting surfaces of the conveyor. A plurality of unloading stations are usually provided, at which unloading stations the articles are unloaded, the unloading procedure being governed by an electronic control system, so that sorting of articles is achieved. When an article has been unloaded from a load supporting surface of the conveyor, that load supporting surface may, at an unloading station, be loaded with a further article. From the unloading stations, the articles are conveyed by other means, such as by trucks, to their destination or to a further transportation means, such as an air plane, for further transportation of the articles.

A number of cross-belt conveyors are known from the prior art. U.S. Pat. No. 4,096,936, EP 0 700 844 A1, U.S. Pat. Nos. 4,712,965, 4,801,000, 4,815,582, 4,884,676, EP 0 343 613, EP 0 633 208 disclose various kinds of cross-belt conveyors constituting a closed loop in either a vertical or in a horizontal plane. Further cross-belt conveyors are known from U.S. Pat. No. 5,547,084, GB-A-2300612, U.S. Pat. Nos. 3,550,748 and 4,781,281.

EP 0 700 844 A1 discloses a cross-belt conveyor in which an article having a length smaller than a predetermined value is loaded onto a single cross-belt, whereas an article having a length greater than a predetermined value is loaded onto two contiguous cross-belts. In case, an articles is loaded onto two contiguous cross-belts, the loading conveyor and the cross-belts are operated so as to rotate the article while loading it. The loading conveyor is arranged at an angle to the cross-belt conveyor.

EP 0 343 613 is concerned with a control system for a cross-belt conveyor and an associated loading conveyor arranged at an angle to the cross-belt conveyor. Thus, at the loading conveyor, the speed of the loading conveyor and the speed of the transversely moving cross-belt is adjusted, so that an article is loaded at zero relative velocity. EP 0 343 613 also mentions the possibility of centering an article in relation to a cross-belt unit, so as to obtain a predictable discharge of the article.

Different examples of tilt-tray conveyors are known from EP 0 540 464, WO 95/33669, WO 90/09944 and U.S. Pat. No. 5,054,601.

Sorters having pushers are also known from the prior art, cf. for example U.S. Pat. Nos. 4,711,341, 4,717,011, 4,732,259, 4,760,908, 4,484,677, 4,896,760, 5,027,939, 5,217,105, 5,275,273, 5,333,715.

Conveyors of the above-mentioned kind usually run in either a vertical or a horizontal plane. Examples of conveyors running in a vertical plane are disclosed in U.S. Pat. No. 4,096,936, GB 2 117 341 and U.S. Pat. No. 3,662,874. Examples of conveyors running in a horizontal loop are disclosed in WO 98/47797 and WO 90/09944.

Examples of loading conveyors or installations are known from DE 29 09 292 and EP-B-0 305 755, and as mentioned above EP 0 700 844 and EP 0 343 613 disclose methods of loading articles onto cross-belt conveyors.

### DESCRIPTION OF THE INVENTION

Whereas the prior art systems are concerned with various aspects of cross-belt conveyors, loading conveyors, pusher-type conveyors, etc., each of which has certain advantages and certain disadvantages, the overall object of the present invention is to provide alternatives to and improvements for such conveyors with the aim of providing systems which result in more efficient and/or reliable conveyance/sorting of articles.

Thus, the present invention relates to four main aspects:

structural configuration of conveyor units, in particular cross-belt units of cross-belt sortation systems,

control systems for conveyors/sorters and methods of loading of articles to and unloading of articles from conveyors/sorters,

structural configuration of conveyors/sorters having conveyor units being coupled together to form an endless loop in a vertical plane,

utilisation of interstices between conveyor units in sortation systems.

Though the present invention relates to a plurality of aspects and is covered by a plurality of independent claims, it is important to understand that each aspect of the invention may be combined with, be adapted to, co-operate with, be integrated in, incorporate or in any other way employ any feature, system, method or characteristic of any other aspect of the present invention whenever appropriate.

One object of the present invention is to provide a conveyor and/or sorter which is improved in comparison with prior art systems with regard to capacity, flexibility of operation and manufacturing costs. A further object of the invention is to provide a conveyor in which the space provided by the conveyor units is utilised in an optimal way.

It is a still further object of the present invention to provide a conveyor running in a vertical plane which occupies less space than prior art conveyors of this type. Conveyors running in a vertical plane often require relatively high building or floors, as the radii of curvature at the turns which interconnect the upper and lower runs of the conveyors usually have to be relatively large in order to ensure safe passing of conveyor units through the curves.

It is a further object of the present invention to provide a conveyor which makes it possible to load, convey and unload articles which are supported by more than a single conveyor unit in a safe and reliable way. It has been realized by the inventors of the present invention that loading and unloading of articles which are to be or are being supported by more than a single conveyor unit, such as a cross-belt unit, is often difficult, in particular if the weight of the article is unevenly distributed over its length.

It is a further object of the invention to provide a conveyor which is stable and has good track-holding qualities. It is a still further object of the invention to provide a conveyor in which loading and unloading can be easily controlled irrespective of the weight and length of the articles and irrespective of the weight-distribution of the articles. It is a further object of the invention to provide a conveyor in which articles can be manipulated during loading, conveyance and/or discharge in an effective way, so as to enable re-orientation of articles while being conveyed by the conveyor and/or transferred to/from the conveyor.

Where, in the present application, the term “conveyor unit” is used, this term covers any kind of unit capable of supporting and conveying any kind of article. A conveyor unit may comprise one or more receptacles, such as one or more cross-belts, one or more trays, in particular tiltable trays, or any other kind of means suitable for supporting articles. A conveyor unit may further comprise or be connected to means for driving it along a conveyor path. Thus, a conveyor unit may be mounted on a driven chain, e.g., a power driven chain, it may be self-propelled, or it may comprise a carriage or wagon. Any conveyor system defined in the present application may comprise a plurality of such carriages or wagons which are coupled together to form a chain, e.g., a closed loop chain of wagons or carriages which may be driven by linear induction motors, chain drives or any other kind of driving means. The conveyor units may be individually driven. Driving of the conveyor units may be individually controlled in case they do not form a chain, or they may be driven together in groups, or all conveyor units of a conveyor system may be driven together. The conveyor units preferably comprise means for unloading articles, such as cross-belts, preferably power driven cross-belts, or activating means for activating tilting of tiltable trays.

1 Structural Configuration of Conveyor Units

According to a first aspect, the present invention relates to a conveyor system for conveying and/or sorting articles and comprising:

a plurality of conveyor units adapted to run along a conveyor path,

at least one loading station for loading articles onto the conveyor units,

at least one unloading station for unloading articles,

displacement means for displacing an article in relation to a conveyor unit in a transverse direction in relation to the transport direction of the conveyor units,

at least one of the conveyor units comprising stopping means for stopping the transverse displacement of an article in relation to a conveyor unit.

Though not claimed, the present invention relates to, as an independent aspect, a set comprising such stopping and displacement means which may be mounted to conveyor units of an existing conveyor system.

By applying displacement means in connection with stopping means, a relatively cheap and flexible conveyor system or conveyor unit is achieved. Thus, the location of an article on a supporting surface of a conveyor unit may be effectively controlled. The system is furthermore flexible, as it allows a great variety of different sized articles to be conveyed or sorted by a single conveyor system, as the system according to the invention allows sectioning of a supporting surface of a conveyor unit into a plurality of sections, each of which has a smaller surface area than the total surface area of the supporting surface. A particular advantage of the system according to the invention is that it may be relatively easily controlled which areas of the supporting are occupied by articles and which areas of the same supporting surface are unoccupied. A further advantage of the system according to the invention is that the position of a first article in relation to the supporting surface may be controlled independently of the position of a second article in relation to the same supporting surface. Thus, for example, the first article may be discharged from the conveyor unit and the supporting surface while the second article may be forced to stay in its position by the stopping means. Thus, the system has an improved capacity in relation to prior art systems. The displacement means may comprise cross-belts, whereby each conveyor unit preferably comprises a cross-belt.

The stopping means may comprise electronically controlled means which are adapted to stop the displacement means or they may comprise mechanical barrier means. In case of electronically controlled stopping means, such means may be of a pure electronic nature, i.e. the means may consist of or comprise electronic control means. Thus, the surface of each or some of the conveyor units, e.g. the surface of each or some of the cross-belt units, may be divided by control software into two or more areas, each area being controllable so as to support an article. Preferably, the order of loading articles which are placed side-by-side on a cross-belt unit respects the order of the subsequent unloading procedure. Articles may be loaded by a loading conveyor. Loading may be performed from one or both sides of the conveyor or from a loading system arranged in an elevated plane in relation to the conveyor, so as to load articles from above.

The different areas into which a conveyor is divided may be arranged in a single row of 2, 3, 4, 5, 6 or more surfaces, or they may be arranged in a matrix configuration of 2×1, 2×2, 2×3, 2×4, 2×5, 2×6, 3×1, 3×2, 3×3, 3×4, 3×5, 3×6 or any other kind of appropriate configuration for a given application. The supporting surfaces may be constituted by the supporting surfaces of, e.g., cross-belts.

If two or more articles are to be loaded next to each other in a side-by-side fashion on a conveyor unit, those two or more articles may be loaded from above or from a side by a single loading system. Alternatively, the two ore more articles may be loaded by two or more loading systems arranged at different locations along the conveyor path. Such loading systems may be sub-systems of an overall loading system. The loading systems and the displacement means are preferably controlled, so as to correctly load the two or more articles next to each other.

The displacement means are integrated in the conveyor units, and they may comprise electrical, hydraulic or pneumatic activators, tiltable surfaces or any kind of conveyor belts. In particular, as mentioned above, the displacement means may comprise cross-belts units, preferably driven electromotors, such as brush-less DC motors. The present invention provides, according to independent aspects, which will be discussed in detail below, methods of controlling loading and unloading of articles to/from conveyor units and conveyor system, respectively.

In case of conveyor belt(s), different surface characteristics of the belt or belts may be chosen for different applications of the conveyor system, and accordingly further aspects of the invention provide a conveyor system and a conveyor unit wherein the surface characteristics of the belt or belts are dependent on the application of the conveyor system. In particular, the choice of surface characteristics of a conveyor belt may depend on weight, size, geometry, surface characteristics or other characteristics of the articles to be conveyed or sorted.

The location of the barrier means in relation to the supporting surface may be variable. The barrier means may be movable between a stopping position and a non-stopping position. Thereby, a completely flexible system may be achieved.

Each cross-belt unit may be divided into a plurality of belt segments with a mutual spacing between the segments, and one or more pin members projecting from the surface defined by the belt segments are may be provided in at least some of the spaces between the segments, so as to thereby define the mechanical barrier means. The pin member(s) may be movable between a first position wherein it/they project(s) from the surface defined by the belt segments and a second position wherein it/they does/do not project from said surface.

The movement of the pin members may be independently controlled for each of the pin members or for groups of pin members. A plurality of pin members may be provided at different positions along the transport direction of the conveyor system, so as to thereby define a barrier, e.g., a straight line barrier, extending in a predetermined direction, e.g., the transport direction of the conveyor units, or along a predetermined curve.

A plurality of pin members may be provided at different transverse positions in relation to the transport direction of the conveyor system, so as to define a variable sizes or geometries of the two or more portions of the cross-belt unit defined by the barrier.

Each of at least some of the conveyor units may comprise at least two cross-belt units forming a substantially continuous supporting surface for one or more articles. Each cross-belt unit may comprise at least two independently operable sub-units which are separated by further stopping means.

The conveyor system may be driven by a chain drive or by a linear-induction motor (LIM) drive. A linear induction motor drive (LIM) is known per se from U.S. Pat. No. 5,054,601 or WO 90/09944.

The conveyor system may comprise or incorporate any feature, element and/or functionality described below in connection with further aspects of the present invention.

According to a further aspect, the present invention relates to a conveyor unit for a conveyor system for conveying and/or sorting articles, the conveyor unit comprising:

displacement means for displacing an article in relation to a conveyor unit in a transverse direction in relation to the transport direction of the conveyor system,

stopping means for stopping the transverse displacement of an article in relation to a conveyor unit.

The conveyor unit may comprise any feature and characteristic of the conveyor unit described above as well as any feature and characteristic of the independent aspects described below, and may, where appropriate, be incorporated in any of the systems described below.

The present invention also provides a method of operating a conveyor system as described above. The method comprises loading one, two, three, four or more articles onto a conveyor unit having any of the above-mentioned features in a conveyor systems having any of the above-mentioned features. The method may incorporate any functionality disclosed above in connection with the conveyor system or the conveyor unit.

A further aspect of the present invention relates to a conveyor system for conveying and/or sorting articles and comprising:

a plurality of conveyor units adapted to run along a conveyor path,

at least one loading station for loading articles onto the conveyor units,

at least one unloading station for unloading articles,

at least some of the conveyor units comprising at least two supporting surfaces forming a substantially continuous supporting surface for one or more articles.

The system may be adapted to load and/or unload articles to/from the conveyor units while the conveyor units are moving along the conveyor path.

The supporting surfaces may be arranged in a single row of 2, 3, 4, 5, 6 or more surfaces, or they may be arranged in a matrix configuration of 2×1, 2×2, 2×3, 2×4, 2×5, 2×6, 3×1, 3×2, 3×3, 3×4, 3×5, 3×6 or even more supporting surfaces on one or both directions. The supporting surfaces may be constituted by the supporting surfaces of, e.g., cross-belts. Where appropriate, tilt-trays may be applied.

The conveyor units preferably comprise cross-belts defining the supporting surfaces. The rate of recurrence of conveyor units having more than a single cross-belt may be adapted to the recurrence of articles having a length greater than the length of a single cross-belt. Thus, for example, at least 1 out of 25 conveyor units may comprise at least two cross-belt units, such as at least 1 out of 10. At least 1 out of 25 and at the most 1 out of 5 or at the most 1 out of 10 conveyor units may comprise at least two cross-belt units. Each of the conveyor units may comprise at least two cross-belt units.

The system may further comprise at least one loading station for loading articles onto the conveyor units, the conveyor units comprising cross-belts and cross-belt driving means for driving the cross-belts, the loading station comprising article advancing means for advancing articles in a loading direction which is at an angle in relation to the direction in which the conveyor units move along the conveying path, the article advancing means and the cross-belt driving means being operable in such a way that articles having a length smaller than a predetermined length can be loaded onto a single cross-belt and that articles having a length greater than a predetermined length can be loaded onto two or more contiguous cross-belts, whereby, in case an article is loaded onto tow or more contiguous cross-belts, the article advancing means and the cross-belt driving means are operated in such a way that the orientation of an article is maintained during loading of the article onto the cross-belts.

The article advancing means may comprise a belt conveyor.

The belt conveyor may be operable at a speed having a velocity component in a direction parallel to the conveying direction of the conveyor units which is substantially equal to the speed of the conveyor units.

The belt conveyor may be operable at a speed having a velocity component in a direction perpendicular to the conveying direction of the conveyor units which is substantially equal to the speed at which the cross-belt(s) onto which an article is loaded is/are operated at least during the period in which an article contacts the belt conveyor and the cross-belt(s).

The two or more contiguous cross-belts may be operated simultaneously and at substantially identical speeds and accelerations during loading of articles thereon.

The conveyor system may comprise any feature and characteristic of the conveyor unit described above as well as any feature and characteristic of the independent aspects disclosed in the present document, and the conveyor system may, where appropriate, be incorporated in any of the systems disclosed in the present document.

According to a further aspect, the present invention relates to a conveyor system for conveying and/or sorting articles and comprising:

a plurality of conveyor units adapted to run along a conveyor path, each conveyor unit comprising a cross-belt unit which is divided into a plurality of belt segments, each belt segment extending in a transverse direction in relation to the transport direction of conveyor units,

at least one loading station for loading articles onto the conveyor units,

at least one unloading station for unloading articles.

Such a system allows for displacing and/or turning articles in relation to the surface of the conveyor unit by driving at least some of the belt segments at different speeds.

Furthermore, it has been found that cross-belt units which have a single belt and wherein the width of the belt is larger than the distance between the center axes of the driving rollers of the belt are difficult to control due to mechanical instability. By applying belt segments this problem may be circumvented.

The movement of each of the belt segments or each of a plurality of groups of belt segments may be independently controllable.

The conveyor unit may comprise any feature and characteristic described above as well as any feature and characteristic of the aspects described below and may, where appropriate, be incorporated in any of the systems described below.

2 Loading and Unloading Conveyors

As an independent aspect, the invention relates to a conveyor system comprising at least one loading station for loading articles onto the conveyor units, the conveyor units comprising cross-belts and cross-belt driving means for driving the cross-belts, the loading station comprising article advancing means for advancing articles in a loading direction which is at an angle in relation to the direction in which the conveyor units move along the conveying path, the article advancing means and the cross-belt driving means being operable in such a way that articles having a length smaller than a predetermined length can be loaded onto a single cross-belt and that articles having a length greater than a predetermined length can be loaded onto two or more contiguous cross-belts, whereby, in case an article is loaded onto tow or more contiguous cross-belts, the article advancing means and the cross-belt driving means are operated in such a way that the orientation of an article is maintained during loading of the article onto the cross-belts.

The article advancing means comprise a conveyor, such as a belt conveyor which is preferably operable at a speed having a velocity component in a direction parallel to the conveying direction of the conveyor units which is substantially equal to the speed of the conveyor units. Furthermore, it is preferably operable at a speed having a velocity component in a direction perpendicular to the conveying direction of the conveyor units which is substantially equal to the speed at which the cross-belt(s) onto which an article is loaded is/are operated at least during the period in which an article contacts the belt conveyor and the cross-belt(s).

The two or more contiguous cross-belts may be mounted on the same conveyor unit or wagon or on individual conveyor units or wagons. Alternatively, the cross-belts may be mounted in groups on different conveyor units or wagons.

In case a single article is loaded onto two or more cross-belts, the two or more contiguous cross-belts may be operated simultaneously and at substantially identical speeds and accelerations during loading of articles thereon. They may, alternatively, be operated at varying speeds and/or varying accelerations.

The conveyor system may comprise any feature and characteristic of the conveyor unit described above as well as any feature and characteristic of the independent aspects disclosed in the present document, where appropriate, be incorporated in any of the systems disclosed in the present document.

Articles may be unloaded such that when unloading of articles at the one or more unloading stations, two or more contiguous cross-belts supporting a single article are activated simultaneously and at substantially identical rates of acceleration up to substantially identical speeds. This constitutes an independent aspect of the present invention. Thus, safe unloading of an article is assured irrespective of the weight-distribution of the article.

The conveyor system may be adapted to load and/or unload articles to/from the conveyor units while the conveyor units are moving along the conveyor path. This is an advantage in relation to prior art systems, wherein the conveyor units are stopped at loading and/or unloading stations, as the capacity of the conveyor is improved in comparison to such prior art systems.

According to a further aspect, the invention relates to a conveyor system for conveying and/or sorting articles and comprising:

a plurality of conveyor units adapted to run along a conveyor path,

at least one loading station for loading articles onto the conveyor units and comprising a loading conveyor, the loading conveyor comprising a plurality of parallel belts which are operable at different speeds, such that an article may be reoriented or rotated while being conveyed along the loading conveyor,

at least one unloading station for unloading articles.

The invention also relates to, as an independent aspect, a loading conveyor comprising a plurality of parallel belts which are operable at different speeds.

The conveyor system may comprise any feature and characteristic of the conveyor unit described above as well as any feature and characteristic of the independent aspects disclosed in the present document, and the conveyor system may, where appropriate, be incorporated in any of the systems disclosed in the present document.

According to a further aspect, the present invention relates to a conveyor system for conveying and/or sorting articles and comprising:

a plurality of conveyor units adapted to run along a conveyor path, each conveyor unit comprising at least one cross-belt unit,

at least one loading station for loading articles onto the conveyor units, the loading station comprising an elevated loading conveyor under which the conveyor units may pass, whereby articles may be loaded from above,

at least one unloading station for unloading articles.

By loading articles from above, the space available for a conveyor system and its associated loading conveyors may be utilised optimally. Moreover, two or more articles may easily and efficiently be loaded onto a single conveyor unit, e.g., a cross-belt unit. For example, two articles may be loaded next to each other simultaneously. Preferably, the loading conveyor is arranged at a distance of, e.g. 2-50 cm, above the conveyor units. The conveyor system and the loading conveyor is preferably adapted to synchronize the loading motion of articles with the speed of the conveyor units onto which the articles are to be loaded, so that reliable loading is obtained.

Preferably, the conveyor units may pass under the loading conveyor at two locations along the conveyor path, so that loading by a single loading conveyor may be performed at two locations along the conveyor path.

The loading station described above allows for an improved loading capacity. Usually the loading capacity is limited by the characteristics of the loading conveyor and associated parts, such as means causing displacement of articles from the loading conveyor to the conveyor units. The loading station and the loading conveyor described above circumvent such limits. Furthermore, such a loading station and loading conveyor allows for continuously loading of articles to the conveyor units.

Each conveyor unit may be divided into at least two sub-units which are arranged next to each other in a direction transverse to the transport direction of the conveyor units.

Preferably, at least one unloading station is provided between the two locations along the conveyor path.

Two or more loading conveyors may be arranged next to each other at the loading station, such that loading may be performed simultaneously at four or more locations along the conveyor path.

The conveyor units may further comprise any features and characteristics of the conveyor units described in the present applications.

The conveyor system may comprise any feature and characteristic of the conveyor unit described above as well as any feature and characteristic of the independent aspects disclosed in the present document, and the conveyor system may, where appropriate, be incorporated in any of the systems disclosed in the present document. In particular, the conveyor system may be a system as described above which comprises a plurality of conveyor units adapted to run along a conveyor path, at least one loading station for loading articles onto the conveyor units, at least one unloading station for unloading articles, displacement means for displacing an article in relation to a conveyor unit in a transverse direction in relation to the transport direction of the conveyor units, at least one of the conveyor units comprising stopping means for stopping the transverse displacement of an article in relation to a conveyor unit.

According to a further aspect, the present invention relates to a method of loading articles onto conveyor units, the method utilising the possibilities offered by the loading station described above. According to a still further independent aspect, the present invention relates to a method of controlling such a loading station, in particular a method of optimising loading of articles for the optimal capacity of the conveyor system.

According to a further aspect, the present invention relates to a conveyor system for conveying and/or sorting articles and comprising:

a plurality of conveyor units adapted to run along a conveyor path,

at least one loading station for loading articles onto the conveyor units, the loading station comprising a loading conveyor which is adapted to load articles onto the conveyor units in a sideways direction in relation to the transport direction of the conveyor units, the loading conveyor being further adapted to load at least two articles onto a single conveyor unit, so that the at least two articles are being arranged next to each other in a direction transverse to the transport direction of the conveyor units.

at least one unloading station for unloading articles.

The above-mentioned “sideways direction” may be any direction which is not parallel to the transport direction of the conveyor units.

The conveyor units may comprise the any features and characteristic described in connection with conveyor units in the present application. In particular, the conveyor units may comprise cross-belts, as cross-belts allow for easy sideways displacement of articles in relation to the transport direction of the conveyor units. This is beneficial during the process of loading articles onto the conveyor units. The loading conveyor may be at an acute angle in relation to the conveyor path.

The conveyor system may comprise any feature and characteristic of the conveyor unit described above as well as any feature and characteristic of the independent aspects disclosed in the present document, and the conveyor system may, where appropriate, be incorporated in any of the systems disclosed in the present document.

According to a further aspect, the present invention provides a method for conveying articles along a conveyor in a conveying direction, the conveyor comprising:

a plurality of conveyor units,

a plurality of cross-belt units for loading and unloading articles in a loading direction perpendicular to the conveying direction, each cross-belt unit comprising a drive for driving the respective cross-belts in the loading direction,

a drive for driving the conveyor units in the conveying direction,

at least one loading station for loading articles onto the conveyor,

at least one discharge station for discharging articles from the conveyor,

the method comprising:

(i) loading an article onto a single cross-belt unit in case the article has a length smaller than or equal to the width of the cross-belt unit,

(ii) loading an article onto two or more cross-belt units in case the article has a length greater than the width of a single cross-belt unit,

(iii) conveying the article along the conveyor in the conveying direction,

(iv) discharging the article at a selected discharge station, the step of loading or discharging comprising:

(a) in case the article is loaded onto/discharged from a single cross-belt unit: activating the cross-belt unit so as to load/discharge the article in a direction transverse to the conveying direction,

(b) in case the article is loaded onto/discharged from two or more cross-belt units: activating the two or more cross-belt units, whereby the two or more cross-belt units are accelerated at at least two different rates of acceleration.

The different rates of acceleration are preferably achieved by activating motors driving the cross-belts at different rates of acceleration, the motors preferably driving the cross-belts in a direction substantially perpendicular to the conveying direction via at least one roller engaging the cross-belt without any slippage between the at least one roller and the cross-belt at the points where the roller(s) is/are in contact with the cross-belt.

Step (b) has the advantage of ensuring a safe manipulation of articles at loading stations/discharge stations irrespective of the distribution of weight along the length of the article.

The two or more cross-belt units may be activated substantially simultaneously or at different time instants. An upstream cross-belt unit may be accelerated at a higher rate of acceleration than a downstream cross-belt unit, or downstream cross-belt unit may be accelerated at a higher rate of acceleration than an upstream cross-belt unit. For discharging purposes to one side of the conveyor, a downstream conveyor unit is usually accelerated at a higher rate than an upstream conveyor unit, so as to rotate the front end of the article to be discharged towards a discharge station. For loading of articles from a loading conveyor located at one side of the conveyor, an upstream conveyor unit is usually accelerated at a higher rate than a downstream conveyor unit, so as to rotate the rear end of the article to be loaded from the loading conveyor towards the main conveyor. In the present context, “upstream” means a rear end as seen in the conveying direction of a conveyor, and “downstream” means front end as seen in the conveying direction of a conveyor.

In case the conveyor units comprise cross-belts, the cross-belts are preferably arranged at distances from each other in the direction of movement of the conveyor, at least some of the interstices thereby formed being provided with passive surface parts having a friction coefficient which is different from the friction coefficient of the carrying surfaces of the cross-belts, the step of unloading comprising loading an article onto at least one cross-belt unit and onto at least one of said passive surface parts.

The step of loading/discharging, in case the article is loaded onto/discharged from two or more cross-belt units, may comprise operating the conveyor and at least one of the cross-belt units in a manner which rotates the articles while being discharged or while resting thereon. Alternatively or additionally, the cross-belt units may be operated so as to manipulate an article while the article is being conveyed along the conveyor. Rotating of an article may comprise activating at least one of the cross-belt units and utilising the difference in friction coefficients between the one or more passive surface parts and the cross-belt units for rotating the article.

The method may comprise any functionality of the conveyor units and systems described above as well as any functionality of the independent aspects disclosed in the present document, and the method may, where appropriate, be incorporated in any of the systems disclosed in the present document.

According to a further aspect, the present invention provides a conveyor incorporating a control system for controlling/initiating operation of the conveyor in accordance with the method of the third aspect of the invention. Such a conveyor may, e.g., be a conveyor according to the first and/or the second aspect of the invention. The conveyor may comprise any feature and characteristic of the conveyor units, conveyor systems and methods described above as well as any feature and characteristic of the independent aspects disclosed in the present document, and the conveyor may, where appropriate, be incorporated in any of the systems disclosed in the present document.

The articles may be fed to the conveyor by means of an induction conveyor conveying articles in an induction direction which is transverse to the conveying direction.

The induction direction and the conveying direction may define an acute angle.

The induction direction may be substantially perpendicular to the conveying direction.

The induction conveyor may be connected to the conveyor, the induction conveyor being adapted to convey articles in an induction direction which is transverse to the conveying direction.

The control system may be adapted to, in case the article is to be loaded onto two or more cross-belt units, operate the induction conveyor and at least one of the cross-belt units in a manner which rotates the articles while being loaded.

According to a further aspect, the present invention relates to a conveyor system for conveying and/or sorting articles and comprising:

a plurality of conveyor units adapted to run along a conveyor path,

at least one loading station for loading articles onto the conveyor units,

at least one unloading station for unloading articles,

unloading of articles being controllable, so that unloading may be activated at different predetermined locations of the conveyor units in relation to an unloading station, whereby sorting or distribution of articles is achieved at the unloading station while unloading articles. In many embodiments of the invention, the conveyor system comprises a chute at the unloading station. Thus, the method may comprise timing discharging of articles, so that articles may slide along the chute at different predetermined positions along the width of the chute, the chute normally extending in a substantially transverse or even perpendicular direction in relation to the transport direction of the conveyor units.

Controlling unloading of articles is preferably performed, so that unloading may be activated at different predetermined locations of the conveyor units in relation to an unloading station, whereby sorting of articles is achieved at the unloading station while unloading articles. In cross-belt systems or in tilt tray systems with electrically activated tilting operation of tilt-trays, controlling of unloading is preferably carried out by means of a control system which is adapted to initiate unloading at different locations in relation to an unloading station. Controlling and in particular timing of unloading may be performed as a function of one or more parameters, such as the weight of an article, the weight distribution of an article over its length, the velocity of the conveyor along the conveying path, the rate of acceleration of the cross-belt during activation thereof or the speed to which the cross-belts are accelerated when activated. In case an article occupies more than a single cross-belt unit, the cross-belt units supporting that article may be activated at different rates of acceleration or they may be accelerated to different speeds, so as to rotate/re-orient the article while being unloaded or so as to take into account an uneven weight-distribution of the article resulting in varying friction characteristics along the length of the article.

As a general independent aspect of the present invention, multiple cross-belts supporting a single article may be activated at substantially identical rates of acceleration to substantially identical speeds, whereby the article is not re-oriented or rotated while being unloaded.

Similarly, the present invention relates to, as an independent aspect, a system and a method for loading an article which is to be supported by multiple cross-belts, whereby those cross-belts are accelerated to substantially identical loading speeds, whereby the article is not re-oriented or rotated while being loaded onto the conveyor. The rates of acceleration at which the cross-belts are accelerated to the loading speeds may be different or substantially identical for the cross-belts.

The conveyor system may comprise any feature and characteristic of the conveyor units, conveyor systems and methods described above as well as any feature and characteristic of the independent aspects disclosed in the present document, and the conveyor system may, where appropriate, be incorporated in any of the systems disclosed in the present document.

An independent aspect of the invention relates to a method of unloading articles in a conveyor system as describe above. A further independent aspect of the invention relates to a method of operating such a conveyor system, the method comprising controlling unloading in accordance with predetermined data or user inputs. Thus, predetermined sorting or distribution of articles may be performed at the unloading station, e.g. in the chute. As an example, half of the articles being unloaded at the unloading station in question may be unloaded so that they reach the unloading conveyor or chute at one location, e.g. at one side, whereas the other half of the articles may be unloaded at the unloading station in question may be unloaded so that they reach the unloading conveyor or chute at another location, e.g. at another side. Such unloading at three, four or even more unloading locations at a chute or another kind of receiving means may be controlled.

The methods may comprise any functionality of the conveyor units and systems described above as well as any functionality of the independent aspects disclosed in the present document, and the methods may, where appropriate, be incorporated in any of the systems disclosed in the present document.

According to a further aspect, the invention relates to a conveyor system for conveying and/or sorting articles and comprising:

a plurality of conveyor units adapted to run along a conveyor path,

at least one loading station for loading articles onto the conveyor units,

at least one transfer station for transferring articles to one or more unloading stations,

at least one posterior conveyor onto which articles may be loaded at the transfer station, the posterior conveyor being adapted to sort articles into the one or more unloading stations.

Thus, improved sorting capacity may be achieved in comparison to a conveyor system having no such posterior conveyor or sorter at at least some of the unloading stations, as post-sorting may be carried by respective posterior conveyors/posterior sorters at each or some of the unloading stations of the conveyor system. The posterior conveyor may comprise any kind of sorter or conveyor, e.g., a cross-belt conveyor, a tilt tray conveyor, a pusher-type conveyor. The posterior conveyor may be adapted to run in a vertical plane or in a horizontal plane. A particularly flexible type of posterior conveyor is a conveyor based on the disclosure of WO 99/35064 capable of moving in as well horizontal as vertical planes. In case, the posterior conveyor is to be mounted in connection with an existing conveyor system, the posterior conveyor is usually rather small in relation to the conveyor of the conveyor system. The posterior conveyor is normally fed at a single location, namely at a single unloading location of a conveyor system. However, the posterior conveyor may alternatively be fed at a plurality of locations, such as different unloading locations of a single conveyor system, or a plurality of unloading stations of two ore more conveyor systems.

The conveyor system may comprise any feature and characteristic of the conveyor units, conveyor systems and methods described above as well as any feature and characteristic of the independent aspects disclosed in the present document, and the conveyor system may, where appropriate, be incorporated in any of the systems disclosed in the present document.

According to an independent aspect, the invention relates to an unloading system for installation at an unloading station of a conveyor system, the unloading system comprising a posterior conveyor as defined above. Such an unloading system is particularly useful for installation at an existing conveyor and/or sorting system, wherein, e.g., improved sorting capacity is desired.

The posterior conveyor may comprise a plurality of supporting surfaces for articles and means for unloading articles, such as trays, e.g., tilt-trays, cross-belts etc. The posterior conveyor may comprise a carrousel. The posterior conveyor may comprise means for unloading articles into, e.g., chutes. Such means may comprise cross belts, activating means for tilt-trays, electrical, hydraulic or pneumatic activators, etc.

The unloading system may comprise any feature and characteristic of the conveyor units, conveyor systems and methods described above as well as any feature and characteristic of the independent aspects disclosed in the present document, and the unloading system may, where appropriate, be incorporated in any of the systems disclosed in the present document.

According to a further aspect, the present invention relates to a conveyor unit for a conveyor system for conveying and/or sorting articles, the conveyor unit comprising a cross-belt unit which is tiltable, so as to achieve unloading by driving the cross-belt and/or by tilting the cross-belt. Thus, a safe, reliable and flexible unloading operation may be ensured. A tiltable cross-belt unit is an advantage, e.g., in conveyor systems wherein articles are to be conveyed which have outer surface geometries, such as sphere-like geometries, and surface characteristics for which pure tilt-tray conveyors and pure cross-belt conveyors are unsuitable. The parts supporting the cross-belt may, e.g., by pivotally mounted around an axis, e.g., a horizontal axis, extending in the longitudinal direction of the conveyor unit, i.e., the transport direction of the conveyor unit along the conveyor path. An arrangement for tilting the cross-belt unit may comprise any kind of device known per se for tilting tilt trays in tilt-tray systems, such as, e.g., the tilting device disclosed in WO 90/09944. Alternatively or additionally, hydraulic, pneumatic, electric or any other kind of powered means may be provided for tilting the cross-belt unit. The invention further relates to a conveyor system comprising a plurality of such conveyor units, a method of conveying articles by means of such a conveyor system, and a method of controlling such a conveyor system.

The conveyor unit, the conveyor system and the methods may comprise any feature and characteristic of the conveyor units, conveyor systems and methods described above as well as any feature and characteristic of the independent aspects disclosed in the present document, and they may, where appropriate, be incorporated in any of the systems disclosed in the present document.

According to a further aspect, the present invention relates to a method for loading and/or unloading articles onto/from a conveyor unit in a conveyor system that comprises:

a plurality of conveyor units adapted to run along a conveying path in a transport direction, each of the conveyor units comprising:

one or more cross-belts for supporting, loading and/or unloading one or more articles,

driving means for driving the cross-belt(s) in a direction transverse to said transport direction,

at least one loading station for loading articles onto the conveyor units,

at least one unloading station for receiving articles being unloaded from the conveyor units,

a control system for controlling the driving means, so as to load or unload the one or more articles at the loading or unloading stations, respectively,

the method comprising:

sending an activation signal to the driving means of a particular cross-belt(s) when said particular cross-belt(s) is/are to be activated,

initiating acceleration of said particular cross-belt(s) by means of the driving means after a predetermined delay time, the delay time being the time elapsing between sending of the activation signal and activation of the driving means for accelerating said particular cross-belt(s),

accelerating, according to a predetermined velocity ramp which is a function of at least one predetermined parameter, said particular cross-belt(s) to a predetermined velocity,

keeping the predetermined velocity for a predetermined time,

decelerating, according to a predetermined velocity ramp which is a function of at least one predetermined parameter, said particular cross-belt(s).

The acceleration and deceleration of the one or more cross-belt(s) may be carried out according to predetermined velocity ramps. Alternatively, only the acceleration or deceleration may be carried out according to a predetermined velocity ramp.

The predetermined velocity to which the particular cross-belt(s) is decelerated may be zero.

The velocity ramp for acceleration and/or the velocity ramp for deceleration ramp may be functions of time.

The steps may be carried out when loading and/or unloading one or more articles. Preferably, the step of sending an activation signal may be carried out a predetermined delay time prior to loading and/or unloading an article. The delay time may be the time elapsing between the moment where the signal is transmitted and the moment where the cross-belt(s) is/are activated.

The cross-belt(s) may be accelerated and decelerated according to a velocity ramp which is not predetermined and which is not a function of any parameters, but for ensuring a precise loading and unloading, the cross-belt(s) is/are preferably activated according to predetermined a velocity ramp(s) when loading and/or unloading articles.

The method for loading and/or unloading articles will be described in details below.

The control system for controlling the driving means may comprise a distributed control system having control means on each or some of the conveyor units for controlling the driving means, and a central control system that comprises:

means for sensing if a conveyor unit is occupied by one or more articles,

signal transmitting means for transmitting signals from the central control means to the distributed control system,

signal receiving means for receiving signals from the distributed control system.

The central control system may be adapted to communicate with the distributed control system via the signal transmitting means and the signal receiving means, so as to control the driving means when loading or unloading the one or more articles.

Prior to sending an activation signal for activating the driving means, the method may further comprise the steps of conveying the conveyor unit along the conveying path in said transport direction past the means for sensing if the conveyor is occupied by one or more articles or not. A signal may be transmitted to the central control system indicating whether the conveyor unit is occupied or not.

Next, the conveyor unit may be conveyed further along the conveying path in said transport direction past signal transmitter means adapted to co-operate with the conveyor units, so as to, e.g. transmit a signal from the central control system to the distributed control system indicating at least the velocity of a conveyor unit. Subsequently, the distributed control system may determine one or more velocity ramp(s), rate(s) of acceleration and/or deceleration and velocity of the cross-belts when loading and/or unloading the one or more articles. Preferably, the distributed control system selects one or more predetermined ramp(s) from a table having predetermined ramps for each values of the velocity of the conveyor unit. Next, the conveyor unit may be conveyed further along the conveying path in said transport direction past signal receiving means, and a signal may be transmitted from the distributed control system to the central control system, via the signal receiving mean, indicating the status of the driving means. Preferably, the signal indicates at least a status for the operation of the driving means, such as if the driving means function properly, or if the amount of current delivered to the driving means is sufficient, or if one or more cross-belt(s) are driving, or if there is an error in the calibration of the driving means, or if the driving means pick up to much current.

Subsequently, the conveyor unit may be conveyed further along the conveying path in said transport direction past further signal transmitting means, and the activation signal may be transmitted from the central control system to the distributed control system via the further signal transmitting means, indicating the delay time and/or a loading station and/or unloading at which the one or more articles are to be loaded and/or unloaded from/to the conveyor unit, respectively, and/or the weight and/or size of the one or more articles to be loaded or unloaded and/or the position of the one or more articles at the loading station and/or unloading station and/or if the one or more articles are to be loaded and/or unloaded from/to the left and/or right side of the conveyor unit. Preferably, the delay time is the time elapsing between sending of the activation signal and activation of the driving means for accelerating the particular cross-belt(s). Primarily, the delay time is adapted for taking into account the variation in the velocities of the conveyor unit.

Subsequently, the conveyor unit may be conveyed further along the conveying path to the loading and/or unloading station while the delay time elapses. When the delay time has elapsed and the conveyor unit has entered the loading or unloading station, the distributed control system may accelerate said particular cross-belt(s) by means of the driving means for loading or unloading the one or more articles. The particular cross-belt(s) may be accelerated, according to a predetermined velocity ramp, to a predetermined velocity and being kept at the predetermined velocity for a predetermined time. After the predetermined time, the cross-belt(s) may be decelerated, according to a predetermined velocity ramp, preferably to a velocity of approximately zero.

The velocity ramp(s) for loading may be different from the velocity ramp(s) for unloading, and the velocity ramp(s) for accelerating may be different from the velocity ramp(s) for decelerating.

The driving means may comprise DC motors, such as brushless DC motors, non-synchronous DC motors, synchronous motors. Alternatively, the driving means may comprise AC motors.

Preferably, the means for sensing if a conveyor unit is occupied by one or more articles comprise at least one photo cell being positioned along the conveying path. Alternatively, the means for sensing may comprise other electronically means such as cameras, e.g., CCD cameras, infrared transmitters/receivers or any kind of mechanical means that indicate if the conveyor unit is occupied by one or more articles.

The signal transmitting means may comprise at least one wireless transmitter being positioned near the conveying path, so that signals may be transmitted from the central control system to the distributed control system by means of the wireless transmitter when the conveyor unit passes the transmitter. The signal may comprise infrared signals transmitted from infrared transmitters. Alternatively or additionally, the wireless transmitters may comprise any other kind of transmitters transmitting signals, such as radio senders. Preferably, the signal transmitting means comprise a plurality of infrared transmitters, each of which being positioned upstream of a loading and an unloading station, respectively. Alternatively, the signal transmitting means may comprise non-wireless transmitters that transmit signals when two or more parts of the non-wireless transmitter are in contact with each other.

The signals from the wireless transmitters may indicate the velocity of the conveyor unit and/or the delay time and/or a loading or unloading station at which the one or more articles are to be loaded or unloaded, respectively and/or the weight and size of the one or more articles to be loaded and/or the position of the one or more articles at the loading station and/or if the one or more articles are to be loaded and/or unloaded from/to the left or right side of the conveyor unit.

Each or some of the signals may be transmitted to the distributed control system by different wireless transmitters.

The signal receiving means may comprise at least one wireless receiver being positioned near the conveying path, so as to receive signals from the distributed control system when the conveyor unit passes the receiver. The wireless receiver may comprise an infrared receiver being adapted to receive infrared signals. Alternatively, the wireless transmitters may comprise any other kind of transmitters transmitting signals, such as radio senders. The signal receiving means may comprise a plurality of infrared receivers being positioned near and along the entire length of the conveying path. The signal receiving means may be adapted to receive status signals from the distributed control system and/or adapted to reset the status stored in the control means. Alternatively, the signal transmitting means may comprise non-wireless transmitters that transmit signals when two or more parts of the non-wireless transmitter are in contact with each other.

The velocity ramp for acceleration and/or deceleration may be a function at least one of the following parameters:

the weight of the one or more articles to be loaded and/or unloaded,

the position of the one or more articles to be loaded and/or unloaded,

the velocity of the conveyor unit along the conveyor path,

the position of the conveyor unit(s) in relation to a loading or unloading station at which the loading and unloading action, respectively, is initiated, that position being variable in one embodiment of the invention,

the weight distribution of an article to be unloaded over its length,

the outer dimensions of an articles to be unloaded.

Preferably, the acceleration and/or deceleration is calculated, so as to prevent the one or more articles from overturning when loading and/or unloading, the calculation being based on at least the weight of the one or more articles and the friction coefficient of the surface of the cross-belt(s).

The velocity of the conveyor and conveyor unit may be between 1 m/s and 3 m/s, such as between 1.2 m/s and 2.8 m/s, such as between 1.4 m/s and 2.6 m/s, such as between 1.6 m/s and 2.4 m/s, such as between 1.8 m/s and 2.2 m/s, such as 2.0 m/s.

The delay time may be between 0 milliseconds (ms) and 2 seconds (s), such as between 10 ms and 1.8 s, such as between 30 ms and 1.6 s, such as between 50 ms and 1.4 s, such as between 70 ms and 1.2 s, such as between 90 ms and 1 s, such as between 110 ms and 800 ms, such as between 130 ms and 600 ms, such as between 150 ms and 400 ms, such as between 170 ms and 200 ms, when loading and/or unloading articles.

The rate of acceleration of the particular cross-belt(s) may be between 1 m/s² and 8 m/s², such as between 2 m/s² and 7 m/s², such as between 3 m/s² and 6 m/s², such as between 4 m/s² and 5 m/s², and wherein acceleration may be carried out for an acceleration time between 100 ms and 800 ms, such as between 200 ms and 700 ms, such as between 300 ms and 600 ms, such as between 400 ms and 500 ms, when loading and/or unloading articles.

The predetermined velocity at which said particular cross-belt(s) may be kept after acceleration thereof and prior to deceleration thereof may between 0.1 m/s and 3 m/s, such as between 0.3 m/s and 2.8 m/s, such as between 0.5 m/s and 2.6 m/s, such as between 0.7 m/s and 2.4 m/s, such as between 0.9 m/s and 2.2 m/s, such as between 1.1 m/s and 2.0 m/s, such as between 1.3 m/s and 1.8 m/s, such as between 1.5 m/s and 1.6 m/s, and wherein the predetermined time for keeping the velocity may be between 300 ms and 1200 ms, such as between 400 ms and 1100 ms, such as between 500 ms and 1000 ms, such as between 600 ms and 900 ms, such as between 700 ms and 800 ms, when loading and/or unloading articles.

The rate of deceleration of the particular cross-belt(s) may be between 1 m/s² and 8 m/s², such as between 2 m/s² and 7 m/s², such as between 3 m/s² and 6 m/s², such as between 4 m/s² and 5 m/s², and wherein the predetermined deceleration time may be between 100 ms and 800 ms, such as between 200 ms and 700 ms, such as between 300 ms and 600 ms, such as between 400 ms and 500 ms, when loading and/or unloading articles.

The control system may be adapted to accelerate and/or decelerate said particular cross-belt(s) at a substantially constant rate of acceleration and deceleration, respectively.

The one or more cross-belt(s) may be adapted to load and/or unload the one or more articles from/to the left and/or right side of the conveyor unit.

In a preferred embodiment, the distributed control system may comprise a microprocessor for controlling the driving means, the driving means comprising, e.g., one or more brush-less DC motors, preferably one motor for each driving the cross-belt of each cross-belt unit. Furthermore the distributed control system may comprise a motor controller, a D/A converter for converting digital values to analogous values, and a F/A converter for converting frequency signals from Hall sensors that may be positioned in the motor to analogous voltage, that voltage preferably indicating, e.g. by proportionality, the velocity/rpm of the motor.

During acceleration, constant velocity and deceleration, the microprocessor may compare the analogous voltage from the F/A converter with the predetermined ramp for acceleration, velocity and deceleration of the motor when loading and unloading, so as to compensate for any deviation from the predetermined ramp.

The microprocessor may have, in addition to Hall Sensors in the motor, at least three control signals for controlling, that the acceleration, velocity and deceleration of the DC motor substantially follows the predetermined ramp. The three signals may comprise a first control signal that is inactive when the motor is “free”, a second signal indicating the direction of rotation of the motor, and a third signal indicating the braking (deceleration) of the motor. When the braking signal is activated, two of the windings in the motor will be short-circuited, so as to brake the motor.

When accelerating and keeping a constant velocity, the controlling of the motor may comprise performing controlling of acceleration and velocity by means of the first and second control signals. When decelerating, the motor may be controlled by frequency modulation, so that the motor may alternate between driving and braking, so as to ensure that it substantially follows the predetermined ramp for deceleration. The frequency modulation may comprise alternating between driving and braking the motor with a frequency of between 100 Hz and 700 Hz, such as between 200 Hz and 600 Hz, such as between 300 Hz and 500 Hz, such as 400 Hz.

According to a further aspect, the present invention provides a method for conveying articles in a conveyor system comprising:

a plurality of conveyor units adapted to run along a conveying path in a transport direction, each of the conveyor units comprising:

one or more cross-belts for supporting, loading and/or unloading one or more articles,

driving means for driving the cross-belt(s) in a direction transverse to said transport direction,

at least one loading station for loading articles onto the conveyor units,

at least one unloading station for receiving articles being unloaded from the conveyor units,

a control system for controlling the driving means, so as to load or unload the one or more articles at the loading or unloading stations, respectively,

the method comprising:

loading an article onto one or more conveyor units of the conveyor system,

conveying said article along the conveyor system,

unloading said article from said one or more conveyor units.

The step of loading and/or unloading may be carried out according to the method steps of loading and/or unloading according to any aspect of the present application.

The invention further relates to systems comprising means for performing the above steps as well as any of the above mentioned means and devices.

The above-mentioned methods may comprise any functionality of the conveyor units and systems described above as well as any functionality of the independent aspects disclosed in the present document, and the methods may, where appropriate, be incorporated in any of the systems disclosed in the present document.

3 Structural Configuration of Conveyors/sorters Running in a Vertical Plane

According to a further aspect, the present invention provides a conveyor for conveying and sorting articles and comprising:

a plurality of conveyor units having means for carrying articles, the conveyor units being coupled together to form an endless loop in a vertical plane, wherein the endless loop comprises a part along which an upper and a lower run have a substantially parallel course at a vertical distance from each other, and two loop turning parts, each of which has a curved configuration for interconnecting the upper and the lower run, the diameter of the curve being larger than the vertical distance between the substantially parallel upper and lower rails,

means for driving the conveyor units along the closed loop.

A conveyor of this type has the advantage that the space requirements are reduced in that the height occupied by the conveyor is smaller along most of the length of the conveyor than at the turns.

The means for carrying articles comprise cross-belts, tilt-trays or slats or simply trays for supporting articles. The means for driving the conveyor units comprise one or more linear induction motors for interacting with driving parts provided on at least one of the conveyor units. Such linear induction motors are known per se from WO 90/09944, U.S. Pat. No. 5,054,601 and EP 0 496 046. Alternatively, the means for driving the conveyor units may comprises a chain for engaging at least one of the conveyor units, a chain drive being known per se from, e.g., GB 2 117 341, DE 27 55 147 and U.S. Pat. No. 3,662,874.

One or more power-conducting rails for conducting electrical current and extending along at least part of the closed loop may be provided. At least one of the conveyor units may comprise pick-up means for picking up current from the power-conducting rail. The power being picked up may, e.g., by a single conveyor unit which is electrically connected to one or more further conveyor units, so as to transmit power to these further conveyor units. The power is fed to power-consuming parts of the conveyor units, e.g., cross-belt unit, or to accumulators on the conveyor units for accumulating power. The conveyor units preferably comprise means for transmitting power being picked up by the pick-up means to the power-consuming parts or to the accumulators. The power-rail system described above is described in great detail in Danish Patent Application No. PA 1998 01259.

The cross-belts may be comprised in a cross-belt unit, each conveyor unit comprising a cross-belt unit, each cross-belt unit comprising an electromotor for driving the cross-belt of the respective cross-belt unit.

The at least one power-consuming part may comprise the electromotors of the cross-belt units.

The conveyor may comprise any feature and characteristic of the conveyor units, conveyors and conveyor systems and methods described above as well as any feature and characteristic of the independent aspects disclosed in the present document, and the conveyor may, where appropriate, be incorporated in any of the systems disclosed in the present document.

In a further aspect, the present invention provides a conveyor system for conveying and sorting articles and comprising at least a first and a second conveyor, each of which comprises:

a plurality of conveyor units having means for carrying articles, the conveyor units being coupled together to form an endless loop in a vertical plane, wherein the endless loop comprises a part along which an upper and a lower run have a substantially parallel course at a vertical distance from each other, and two loop turning parts, each of which has a curved configuration for interconnecting the upper and the lower run,

means for driving the conveyor units long the closed loop,

at least one discharge station for receiving articles being discharged from each of the first and second conveyor, respectively,

the conveyor system further comprising at least one induction conveyor for feeding articles onto the upper run of the first conveyor, at least one of the at least one discharge stations of the first conveyor being connected to an induction of the second conveyor.

By connecting the induction of the second conveyor to the discharge station of the first conveyor, the capacity of the conveyor system may be considerable improved, as the total number of discharge stations of the first and second conveyors sum up to the double number of discharge stations as compared to a configuration only comprising a single conveyor. The discharge station of the first conveyor may be designed such that an article is being discharged from the upper run of the first conveyor directly onto the second conveyor. The second conveyor may be of the same type as the first conveyor or of the type wherein conveyor units run in a horizontal plane. Other types of conveyors may also be applied for the second conveyor, e.g., a combined vertical/horizontal conveyor as disclosed in WO 99/35064.

Two or more second conveyors, each of which are connected to a discharge station of the first conveyor, may be provided. Thus, a tree-structure formed by the conveyors may be achieved resulting in very high capacities of the conveyor system.

The means for carrying articles may comprise cross-belt units, tilt-trays or slats or simple trays. The upper run of at least one second conveyor may be substantially parallel to the upper run of at least one first conveyor, whereby articles may be transferred from the very downstream end of the upper run of the first conveyor to the very upstream end of the second conveyor. Alternatively, the upper run of at least one second conveyor and the upper run of the first conveyor may define an acute angle. Both of the aforementioned parallel and acute angle configurations may be applied in the conveyor system.

The conveyor system may comprise any feature and characteristic of the conveyor units, conveyor systems and methods described above as well as any feature and characteristic of the independent aspects disclosed in the present document, and the conveyor system may, where appropriate, be incorporated in any of the systems disclosed in the present document.

In a further aspect, the present invention provides a method for conveying and sorting articles in a conveyor system which comprises at least a first and a second conveyor, each of which comprises:

a plurality of conveyor units having means for carrying articles, the conveyor units being coupled together to form an endless loop in a vertical plane, wherein the endless loop comprises a part along which an upper and a lower run have a substantially parallel course at a vertical distance from each other, and two loop turning parts, each of which has a curved configuration for interconnecting the upper and the lower run,

means for driving the conveyor units long the closed loop,

at least one discharge station for receiving articles being discharged from each of the first and second conveyor, respectively, the conveyor system further comprising at least one induction conveyor for feeding articles onto the upper run of the first conveyor, at least one of the at least one discharge stations of the first conveyor being connected to an induction of the second conveyor, the method comprising the steps of:

(a) feeding an article onto the first conveyor,

(b) conveying the article along the first conveyor to a discharge station of the first conveyor,

(c) discharging the article at the discharge station of the first conveyor,

(d) transferring the article from the discharge station of the first conveyor to the second conveyor, and feeding the article onto the second conveyor,

(e) conveying the article along the second conveyor to a discharge station of the second conveyor,

(f) discharging the article at the discharge station.

The conveyor system may comprise at least two second conveyors, each of which being connected to a discharge station of the first conveyor, step (c) comprising discharging the article at a selected one of the discharge stations which are connected to second conveyors.

4 Utilisation of Interstices Between Conveyor Units

According to a further aspect, the present invention provides a conveyor for conveying and sorting articles and comprising:

a plurality of conveyor units having cross-belts for carrying articles, the conveyor units being coupled together to form an endless loop,

one or more drive means for driving the conveyor units,

the cross-belts being arranged at distances from each other in the direction of movement of the conveyor, at least some of the interstices thereby formed being provided with passive surface parts having a friction coefficient which is different from the friction coefficient of the carrying surfaces of the cross-belts.

The passive surface parts makes it possible to effectively control loading of articles to the conveyor and discharging of articles from the conveyor. Moreover, the passive surface parts contribute to save weight, and thus to save power due to reduced losses in the drive system.

The friction coefficient of the passive surface parts is preferably lower than the friction coefficient of the carrying surfaces of the cross-belts, so as to ensure that an article will move when the cross belt or cross belts on which it is resting moves at a discharge station or at a loading station. The friction coefficient of the passive surface parts is between 0 and 1, usually between 0.01 and 0.5, such as between 0.04 and 0.4, such as between 0.06 and 0.3, such as between 0.08 and 0.25, such as between 0.1 and 0.2. The passive surface parts may be made from a metal, such a aluminium or steel, or from a plastics material, such as polyethylene, such as Teflon. The friction coefficient of the cross belts may be between 0 and 1, such as between 0.25 and 0.95, such as between 0.3 and 0.85, such as between 0.5 and 0.8. The cross-belts may be made from a rubber material. The above-mentioned friction coefficients are defined as the ratio between

the friction force acting on an article resting on a surface and

the force applied be the article to the surface in a direction normal to the surface when the article is being moved in a slipping manner along the surface.

The passive surface parts are preferably arranged at substantially the same level as the carrying surfaces of the cross-belts but they may also be arranged at a lower level, and for certain shapes/configurations of articles, the passive surface parts may even be placed at a higher level than the cross-belts. The width of the passive surface parts is preferably equal to or smaller than the width of the cross-belt units but it may also be larger.

The conveying units may be coupled together to form an endless loop in a vertical plane, wherein the endless loop comprises a part along which an upper and a lower run have a substantially parallel course at a vertical distance from each other, and two loop turning parts, each of which has a curved configuration for interconnecting the upper and the lower run, the diameter of the curve being larger than the vertical distance between the substantially parallel upper and lower rails.

The conveyor may comprise any feature and characteristic of the conveyor units, conveyors and conveyor systems and methods described above as well as any feature and characteristic of the independent aspects disclosed in the present document, and the conveyor may, where appropriate, be incorporated in any of the systems disclosed in the present document.

In a further aspect, the present invention provides a conveyor for conveying and sorting articles and comprising:

a plurality of conveying units having cross-belts for carrying articles, the conveyor units being coupled together to form an endless loop,

one or more drive means for driving the conveyor units in a conveying direction,

at least one loading stations at which articles can be loaded onto the conveyor,

at least one discharge station at which articles can be discharged from the conveyor,

the cross-belts being arranged at distances from each other in the direction of movement of the conveyor,

interstices between the cross-belts,

pushers provided in at least some of the interstices for engaging a side portion of an article when discharging the article at the discharge station,

means for moving the pushers in a direction substantially perpendicular to the surface of the cross-belts between a projecting position in which the pushers project from the surface of the cross-belts in the interstices and a recessed position in the interstices,

means for moving the pushers back and forth in the interstices,

a control system for controlling the movement of the pushers and other operations of the conveyor.

Sorters having pushers are known per se from the prior art, cf. for example U.S. Pat. Nos. 4,711,341, 4,717,011, 4,732,259, 4,760,908, 4,484,677, 4,896,760, 5,027,939, 5,217,105, 5,275,273, 5,333,715. The pushers may be operated to assist in discharging articles from the conveyor. In cases where an article, e.g., has a convex and/or slippery outer surface and/or an uneven distribution of weight along the length of the article, it may happen that the action of the cross-belts does not suffice for discharging the article. In such a case, a force applied to a side portion of the article by one or more pushers may ensure that the article in being properly discharged. At a discharge station, the pushers may be operated so as to rotate the article into the discharge station. The pushers may further be operated so as to manipulate, e.g., to rotate an article while it is being conveyed along the conveyor.

When discharging an article, the pushers may be activated only after one or more cross-belts have acted on an article for a certain time interval. The force applied to the article by the pushers may superimpose the force applied by the cross-belts. The cross-belts and the pushers may also be operated so that they do not act at the same time.

The conveyor may comprise any feature and characteristic of the conveyor units, conveyors and conveyor systems and methods described above as well as any feature and characteristic of the independent aspects disclosed in the present document, and the conveyor may, where appropriate, be incorporated in any of the systems disclosed in the present document.

In a further aspect, the present invention provides a method of conveying and sorting articles in a conveyor comprising:

a plurality of conveying units having cross-belts for carrying articles, the conveyor units being coupled together to form an endless loop,

one or more drive means for driving the conveyor units in a conveying direction,

at least one loading stations at which articles can be loaded onto the conveyor,

at least one discharge station at which articles can be discharged from the conveyor,

the cross-belts being arranged at distances from each other in the direction of movement of the conveyor,

interstices between the cross-belts,

pushers provided in at least some of the interstices for engaging a side portion of an article when discharging the article at the discharge station,

means for moving the pushers in a direction substantially perpendicular to the surface of the cross-belts between a projecting position in which the pushers project from the surface of the cross-belts in the interstices and a recessed position in the interstices,

means for moving the pushers back and forth in the interstices,

a control system for controlling the movement of the pushers and other operations of the conveyor,

the method comprising:

(a) loading an article onto the conveyor at the loading station,

(b) conveying the article to a discharge station,

(c) activating the cross belt or belts which support the article at a discharge station, so as to discharge the article.

Step (c) further may comprise activating one or more pushers, whereby the at least one of the pushers engages a side portion of the article, so as to thereby impose a pushing force on the article, the pushing force thereby at least partly superimposing the action of the cross belt or belts on the article.

According to a further aspect, the present invention provides to a conveyor for conveying and sorting articles and comprising:

a plurality of conveying units for carrying articles, the conveyor units being coupled together to form an endless loop, each conveying unit having an upper side and a bottom side,

one or more drive means for driving the conveyor units in a conveying direction,

at least one loading stations at which articles can be loaded onto the conveyor,

at least one discharge station at which articles can be discharged from the conveyor,

the conveying units being arranged at distances from each other in the direction of movement of the conveyor,

interstices between the conveying units,

pushers provided in at least some of the interstices for engaging a side portion of an article when discharging the article at the discharge station,

pusher moving means for moving the pushers in the interstices in a first direction transverse to the conveying direction, the pusher moving means being adapted to:

move the pushers between a projecting position in which they project from the surface of the conveying units and a recessed position in the interstices,

move the pushers in said first transverse direction when the pushers are in the projecting position,

move the pushers in a second transverse direction opposite to the first transverse direction when the pushers are in the recessed position,

a control system for controlling the movement of the pushers and other operations of the conveyor.

Such a conveyor has the particular advantage that the pushers may be repositioned by means of a simple and cheap construction. Such a construction may, e.g., comprise at least one wire wound around at least two rollers engaging the wire, each roller being adapted to engage the wire and having an axis of rotation which is parallel to the conveying direction. In such an embodiment, each pusher may be mounted to a wire, whereby rotation of the wire causes the wire and the pusher to move in said first transverse direction in the projecting position and in said opposite direction in the recessed position.

The conveyor may comprise any feature and characteristic of the conveyor units, conveyors and conveyor systems and methods described above as well as any feature and characteristic of the independent aspects disclosed in the present document, and the conveyor may, where appropriate, be incorporated in any of the systems disclosed in the present document.

In a further aspect, the invention relates to a method of conveying and sorting articles in a conveyor comprising:

a plurality of conveying units for carrying articles, the conveyor units being coupled together to form an endless loop, each conveying unit having an upper side and a bottom side,

one or more drive means for driving the conveyor units in a conveying direction,

at least one loading stations at which articles can be loaded onto the conveyor,

at least one discharge station at which articles can be discharged from the conveyor,

the conveying units being arranged at distances from each other in the direction of movement of the conveyor,

interstices between the conveying units,

pushers provided in at least some of the interstices for engaging a side portion of an article when discharging the article at the discharge station,

pusher moving means for moving the pushers in the interstices in a first direction transverse to the conveying direction, between a right-hand and a left-hand side of the conveyor and vice versa, the pusher moving means being adapted to:

move the pushers between a projecting position in which they project from the surface of the conveying units and a recessed position in the interstices,

move the pushers in said first transverse direction when the pushers are in the projecting position,

move the pushers in a second transverse direction opposite to the first transverse direction when the pushers are in the recessed position,

the method comprising:

(a) loading an article onto the conveyor at the loading station,

(b) conveying the article to a discharge station,

(c) activating at least one pusher at a discharge station, so as to discharge the article, whereby the at least one pusher engages a side portion of the article, so as to thereby impose a pushing force on the article.

The method may further comprise the step of determining a desired position in which side of the conveyor a pusher which has been used for unloading an article is next needed for unloading an article and determining a current location of the pusher in the interstice, and if the pusher is needed at a location different from the current location:

moving the pusher to its recessed position,

in the recessed position: moving the pusher to the desired position, moving the pusher to its projecting position.

The method may comprise any functionality of the conveyor units and systems described above as well as any functionality of the independent aspects disclosed in the present document, and the method may, where appropriate, be incorporated in any of the systems disclosed in the present document.

In any aspect of the present invention, equipment may be provided for determining length, weight, shape and/or volume of articles, so as to assign an appropriate number of cross-belt units and passive surface parts to each of the articles, and possibly also to apply an appropriate power to unloading means, e.g., cross-belts and/or pushers. Furthermore, in all of the above aspects of the invention, discharge or induction/loading of articles may be carried out while moving only one or some of the cross-belts onto which an article is to be loaded or from which it is to be discharged. Thus, for example when discharging an article which is supported by a plurality of cross-belts, the most rear-end cross-belt supporting the article may remain un-activated while the other cross-belts are moving at different speeds and/or at different rates of acceleration. Other cross-belts may also/alternative remain un-activated while yet others are activated.

### BRIEF DESCRIPTION OF THE DRAWINGS

FIG. 1 is a perspective illustration of a conveyor system according to the invention,

FIG. 2 is a perspective illustration of a first embodiment of a part of a cross-belt unit for use in a conveyor system according to the invention,

FIG. 3 is a perspective illustration of a second embodiment of a part of a cross-belt unit for use in a conveyor system according to the invention,

FIG. 4 is an side-view illustration of a conveyor unit with a barrier means,

FIG. 5 is a perspective illustration of a third embodiment of a part of a cross-belt unit for use in a conveyor system according to the invention,

FIG. 6 is a perspective illustration of a fourth embodiment of a part of a cross-belt unit for use in a conveyor system according to the invention,

FIG. 7 is a perspective illustration of a part of a cross-belt unit for use in a conveyor system according to the invention,

FIG. 7A is an end view of a conveyor unit having two cross-belts,

FIG. 7B is an end view of a conveyor unit having one cross-belt,

FIG. 7C is a schematic top view of a conveyor unit having a 2×2 matrix of cross-belts,

FIG. 8 is a schematic illustration of a layout of a conveyor system according to the invention,

FIG. 9 is a schematic illustration of a loading conveyor for a conveyor system according to the invention,

FIG. 10 is a schematic illustration of a unloading station for a system according to the invention,

FIG. 11 is a top view of a conveyor unit or wagon with two article supporting surfaces supporting a first article,

FIG. 12 is a top view of a conveyor unit or wagon with two article supporting surfaces supporting a second article,

FIG. 13 is a schematic illustration of a part of a conveyor system according to the invention with a first loading conveyor configuration,

FIG. 14 is a schematic illustration of a part of a conveyor system according to the invention with a second loading conveyor configuration,

FIG. 15 is a schematic illustration of a part of a conveyor system according to the invention with a further loading conveyor configuration,

FIG. 16 is a schematic illustration of a part of a conveyor system according to the invention with a further loading conveyor configuration,

FIG. 17 is a schematic illustration of a part of a conveyor system according to the invention with a further loading conveyor configuration,

FIG. 18 shows a part of a conveyor system, wherein a space between two contiguous conveyor units is covered by a flexible body,

FIG. 19 shows the flexible body of FIG. 18 in detail,

FIG. 20 is a perspective view of a track section of a conveyor according to the invention,

FIG. 21 is a perspective view part of the track section of FIG. 20 and a plurality of cross-belt units of a conveyor according to the invention,

FIG. 22 shows a detail of the track section of FIGS. 20 and 21 with three cross-belt units,

FIG. 23 shows a detail of another part of the track section of FIGS. 20 and 21,

FIG. 24 shows a detail of a track section part with frames for carrying a cross-belt unit,

FIG. 25 shows a detail of a track section part with power rails for conduction current from which power can be picked up by a cross-belt unit,

FIG. 26 shows a cross-belt unit in a first view,

FIG. 27 shows the cross-belt unit of FIG. 26 in a second view,

FIG. 28 is a schematic illustration of a conveyor accommodating articles of different sizes,

FIG. 29 is a schematic illustration of a conveyor with loading and unloading stations,

FIG. 30 shows the conveyor of FIG. 29 with an article being discharged from the conveyor at a discharge station,

FIG. 31 shows the conveyor of FIG. 29 with an article being loaded onto the conveyor at a loading station,

FIG. 32 is a schematic illustration of a conveyor having pushers for discharging articles from the conveyor,

FIG. 33 is an illustration of a conveyor system having a control system for controlling loading and unloading of articles,

FIG. 34 shows a diagram of a distributed control system,

FIG. 35 shows a predetermined ramp,

FIG. 36 shows a part of a deceleration ramp.

### DETAILED DESCRIPTION OF THE DRAWINGS

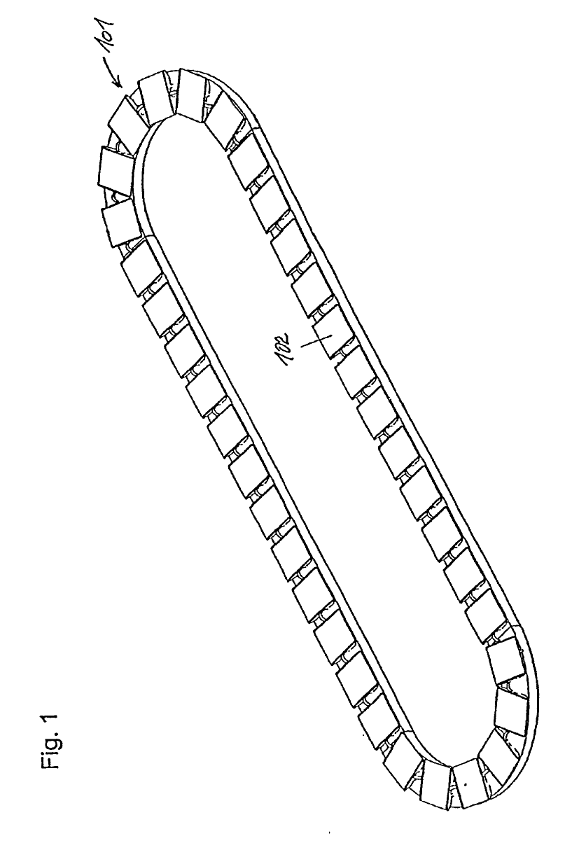

FIG. 1 shows a conveyor system 101 comprising a plurality of conveyor units 102 which are coupled together to form a closed loop. The conveyor system further comprises at least one loading station (not shown) for loading articles onto the conveyor units 102 and one or more unloading/discharging stations (not shown) for unloading articles carried by the cross-belt units.

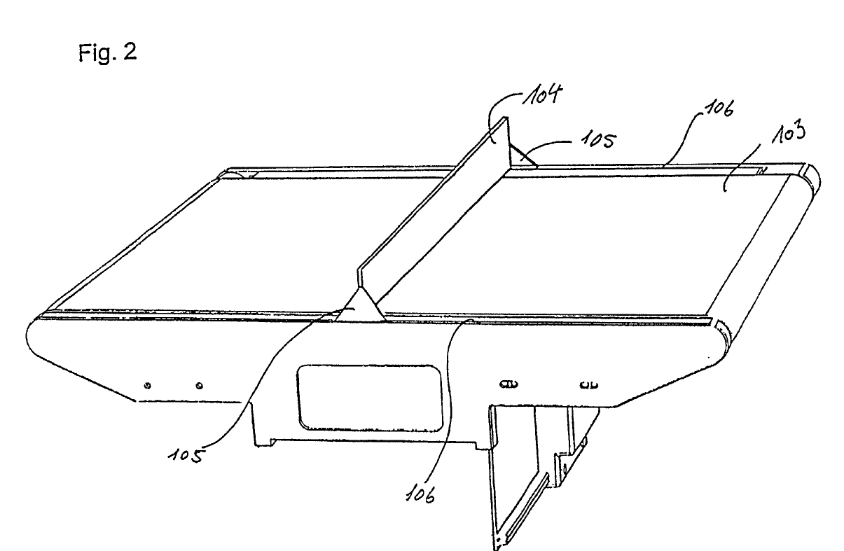

FIG. 2 shows a first embodiment of a part of a cross-belt unit, the part shown in FIG. 2 being adapted to be mounted on a carriage, such as a wagon or a chain drive, so as to form a conveyor unit. The part comprises a cross-belt 103 which is adapted to displace articles in a transverse direction in relation to the transport direction of the conveyor unit, and a barrier 104. The barrier 104 is mounted to the other parts of the cross-belt unit by means of holding members 105 connected to side portions 106 of the cross-belt unit. The cross-belt is driven by an electronically controlled motor (not shown).

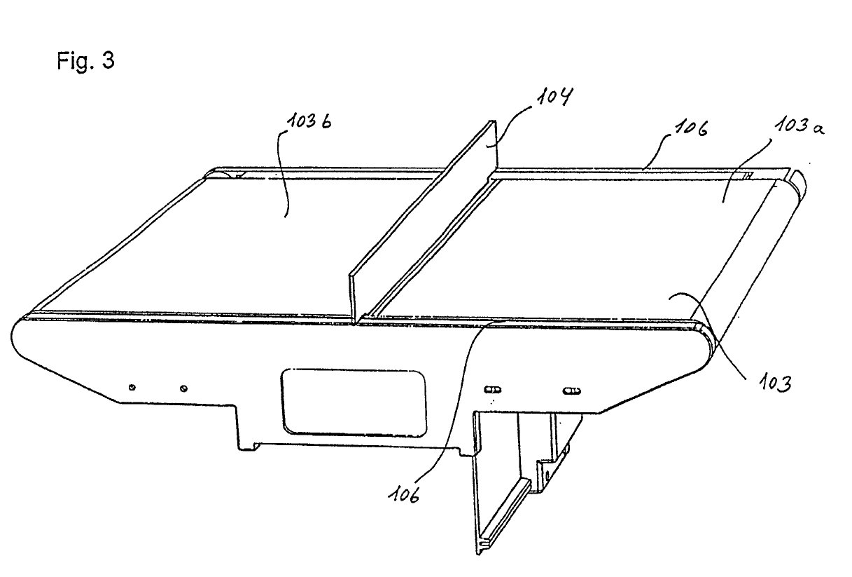

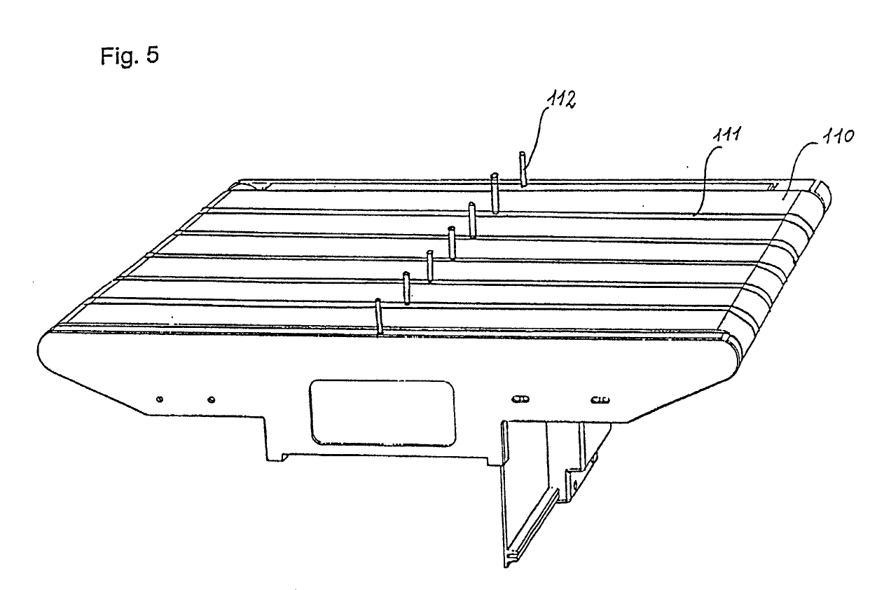

FIG. 3 shows a second embodiment of a part of a cross-belt unit, which is analogue to the part shown in FIG. 2. The barrier 104 is either attached directly to the side portions 106 or supported by barrier supporting means (not shown) located below the cross-belt 103. In the latter case, the cross-belt 103 is either divided into a plurality of cross-belt segments, cf. FIG. 5, and/or divided into a right-hand and a left-hand cross-belts 103a and 103b, respectively. The movement of the right-hand and the left-hand conveyor segment may be independently controllable.

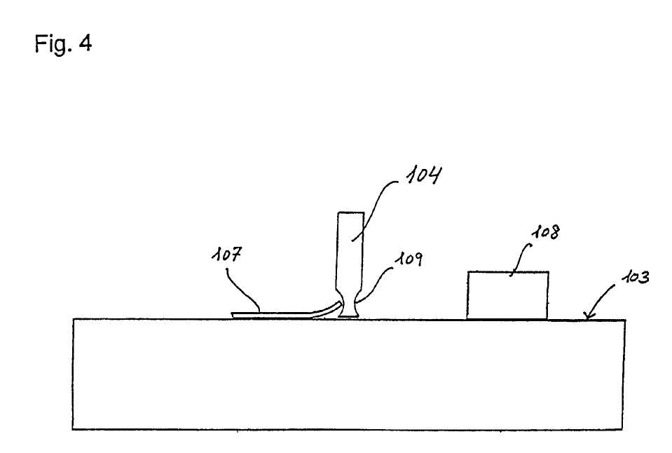

FIG. 4 is a schematic end-view illustration of a cross-belt unit with a barrier 104. The cross-belt 103 supports two articles 107 and 108 located on either side of the barrier. The barrier is provided with a groove 109 which prevents flat articles, such as the article 107, from sliding under the barrier 104.

FIG. 5 shows a third embodiment of a part of a cross-belt unit, which is analogue to the embodiments of FIGS. 2 and 3. The cross-belt is divided into a plurality of belt segments 110 with a mutual spacing 111 between them. The stopping means for stopping the transverse displacement of an articles comprise pin members or pins 112 which are arranged in the spaces 111. The pins 112 may either be fixed in the shown position wherein they project from the surface defined by the belt segments or they may be displaceable from a second position wherein they do not project from the surface defined by the belt segments to the shown position. In case the pins 112 are fixedly mounted in relation to the surface defined by the belt segments, a plate or bar (not shown) connected to the pins 112 and extending across and over the belt segments 110 may be provided, so as to allow an unbroken barrier.

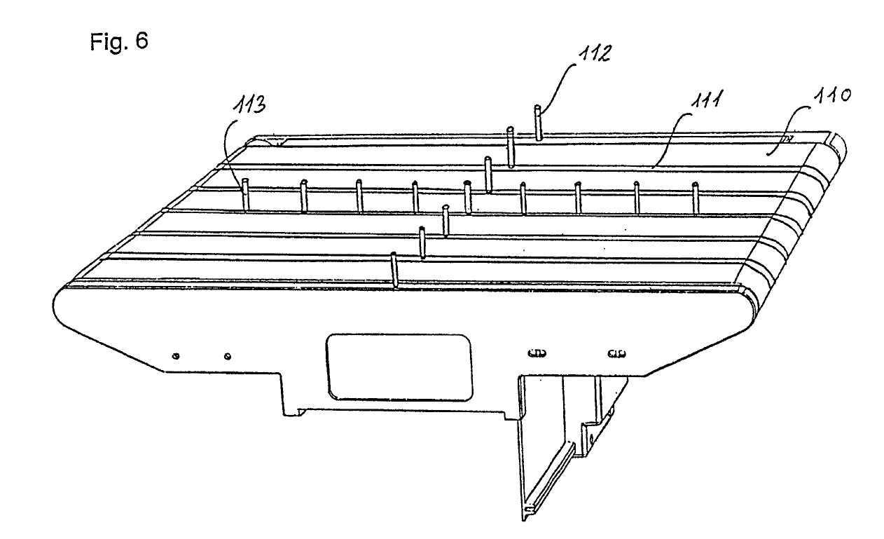

FIG. 6 shows a fourth embodiment of a part of a cross-belt unit wherein further pins are provided. In addition to the pins 112 of FIG. 5, further pins 113 are provided. The remarks set forth in connection with FIG. 5 and the pins 112 also apply to the further pins 113. The pins 112 and 113 may be arranged in rows as shown in FIGS. 5 and 6. However, they may also be arranged along curves. Further pins or rows of pins may be provided so as to generate further kinds of patters. Thereby, a great variety of geometrical configurations/sectioning of the cross-belt may be obtained. Each belt 110 may be individually driven, whereby different articles carried by the conveyor unit may be loaded or unloaded independently. Alternatively, the belts may be connected in groups of, e.g., 2, 3, 4, 5 or more belts, so that each group of belts may be individually driven. In FIG. 6, each belt 110 extends substantially over the entire width of the conveyor unit. In alternative embodiments, additional belts may be provided, analogous to the embodiment described in connection with FIG. 3.

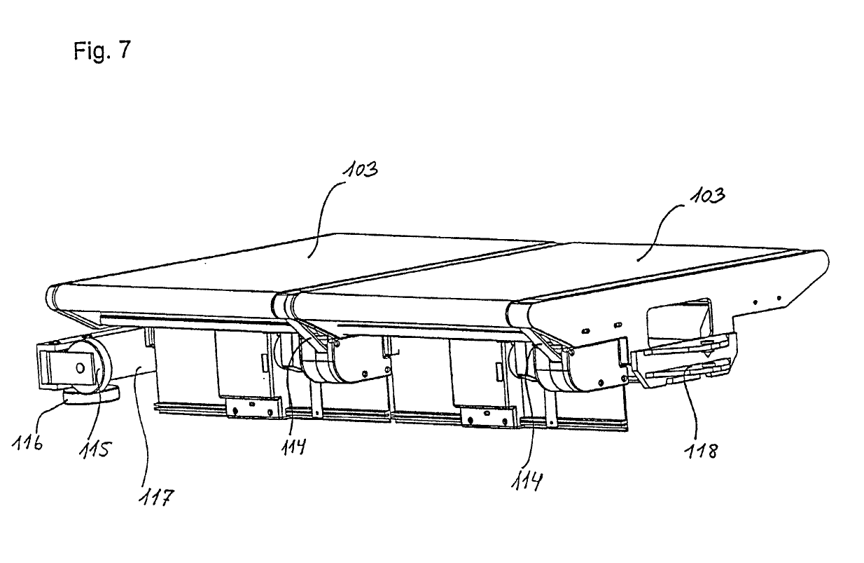

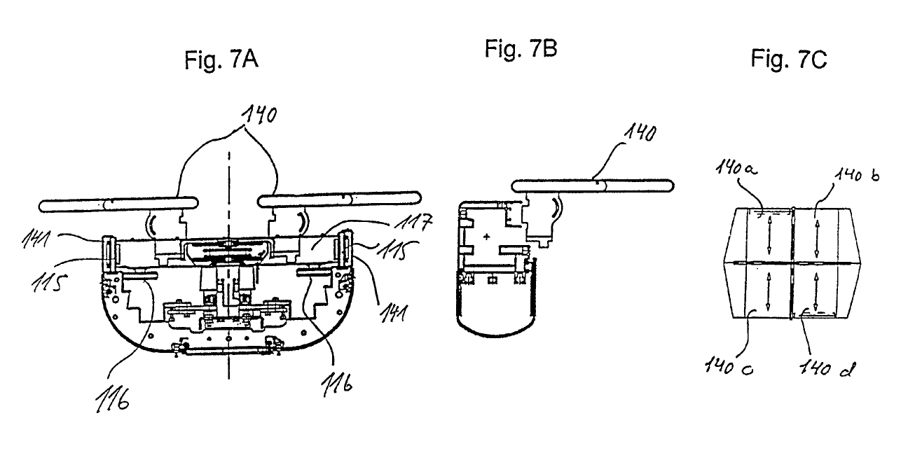

FIG. 7 shows a cross-belt unit having two cross-belts 103 arranged behind each other and defining a common substantially continuous supporting surface for articles. Thus, either two articles occupying one cross-belt 103 each may be conveyed by the conveyor unit of FIG. 7, or a single article occupying both cross-belts 103 may be conveyed. According to the invention, further cross-belt units may be comprised in a cross-belt unit, and they may be arranged in a single row as shown in FIG. 7 or in a matrix configuration. The cross-belts 103 may be divided into a plurality of belt segments (not shown), analogous to the the cross-belts shown in FIGS. 5 and 6. The cross-belt unit shown in FIG. 7 further comprises driving belts 114 for transmitting power from motors (not shown) to the cross-belts 103. The cross-belt unit further comprises wheels or rollers 115 for driving along a conveyor track and guide wheels or rollers 116 for driving along a side portion of the conveyor track. The wheels are connected to a frame structure 117 supporting the cross-belts 113 and associated parts. Coupling means 118 are provided for coupling the front end and the rear end of the conveyor unit to the rear end or the front end, respectively, of another conveyor unit.

FIG. 7A shows a conveyor unit having two cross-belts 140 arranged next to each other in a direction transverse to the transport direction of the conveyor units. The design of the two cross-belt units is preferably identical, so that a single cross-belt unit 140 can be used in an alternative conveyor system, as illustrated in FIG. 7B. The two cross-belt units of FIG. 7A are mirrored in relation to each other. The use of such a “standard cross-belt unit” for different purposes constitutes an independent aspect of the present invention. The conveyor unit shown in FIG. 7A comprises rollers or wheels 115 for running along a track 141 following a conveyor path. Guide wheels or rollers 116 running along a side portion of the track 141 are provided. The conveyor unit further comprises a frame 117.

FIG. 7C is a schematic top view of a conveyor unit having a 2×2 matrix configuration of cross-belts 140a, 140b, 140c and 104d.

The cross-belts 140 and 140a, b, c and d are tiltable, so as to allow a smoother and more gentle unloading of articles in comparison to unloading from, e.g., tilt-trays or conventional cross-belts. Furthermore, energy consumption may be reduced with such a system.

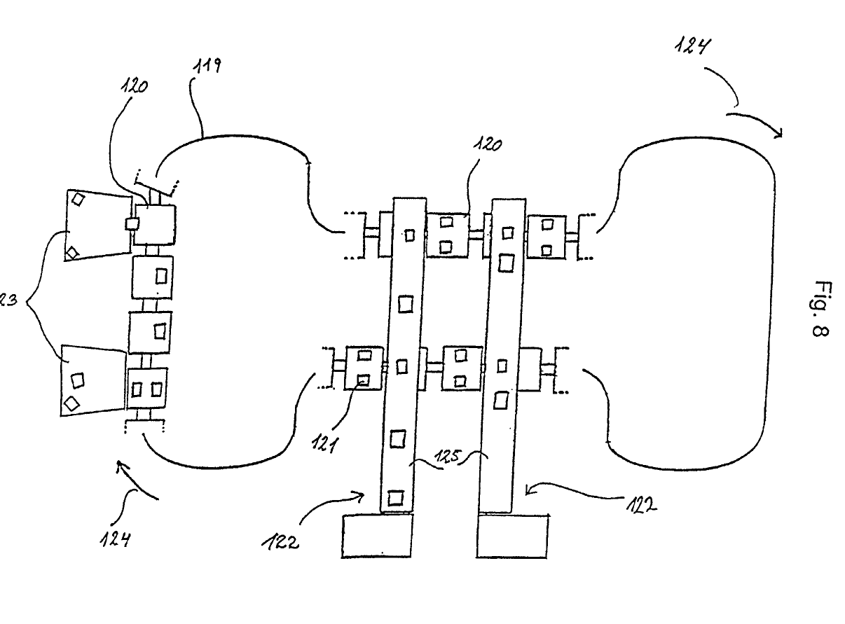

FIG. 8 is a schematic illustration of a layout of a conveyor system. The conveyor system comprises a conveyor path 119 along which a closed loop chain of conveyor units 120 which are adapted to support and conveyor articles 121. The conveyor units may comprise any kind of supporting surface for the articles, including cross-belts and tilt trays. The conveyor system comprises two loading stations 122 for loading articles 121 onto the conveyor units 120 and two unloading stations 123 for unloading articles 121 from the conveyor units 120. The conveyor units are driven in the direction indicated the arrows 124. Each loading station 122 comprises a loading conveyor 125 which runs above the conveyor path 119, whereby articles 121 are loaded onto the conveyor units 120 from above. Each loading conveyor 125 crosses the conveyor path 119 at two crossing locations. At both crossing locations of both loading conveyors 125, articles may be displaced from the respective loading conveyor to the conveyor units 120 running along the conveyor path.

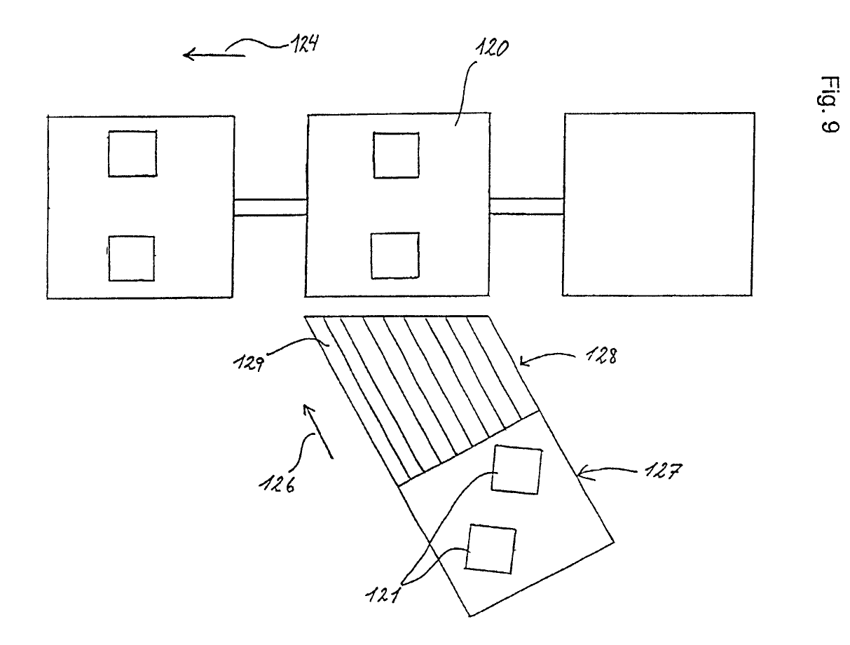

FIG. 9 is a schematic illustration of a loading conveyor 127 for a conveyor system. The loading conveyor of FIG. 9 is adapted to load two articles 121 onto a single conveyor unit 121, so that the two articles are being positioned next to each other on the conveyor unit 120. The conveyor units 120 are driven in the direction indicated by arrow 124, and articles are loaded onto the conveyor units in the direction of arrow 126. A portion 128 of the loading conveyor 127 comprises a plurality of belt segments 129 which are either driven together or individually. In case of individually driven belt segments 129, two articles 121 may be driven at different speeds, so as to adjust their mutual positions. Furthermore, individually driven belt segments 129 allow for turning of articles 121 while conveying them along the conveyor portion 128.

FIG. 10 is a schematic illustration of a unloading station for a conveyor system. The conveyor system comprises conveyor units 120 which are adapted to support and convey articles. At the unloading station, articles may be discharged from the conveyor units 120 to supporting surfaces 130 of a posterior conveyor 131. In the embodiment of FIG. 10, the posterior conveyor comprises a carrousel. From the posterior conveyor 131, articles may be unloaded into article receiving means 132, comprising, e.g., chutes and/or one or more further conveyors.

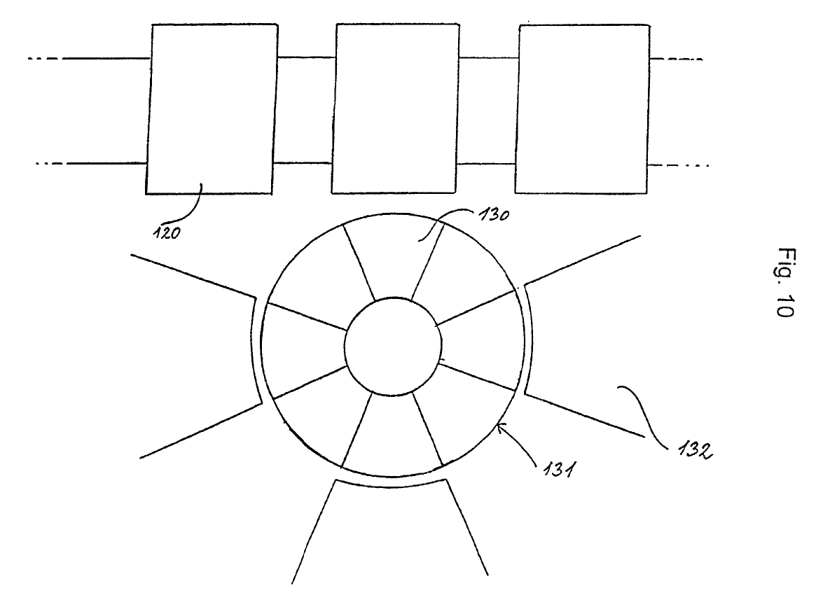

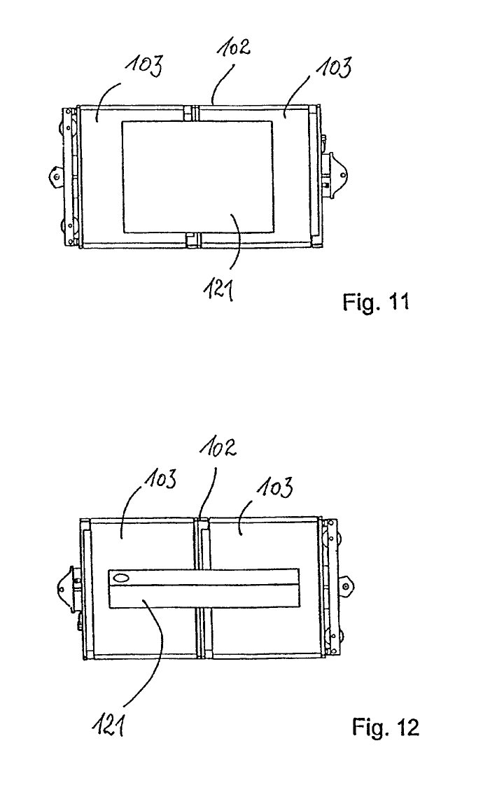

FIGS. 11 and 12 are top views of a conveyor unit or wagon with two cross-belts 103 supporting articles 121 of different shapes.

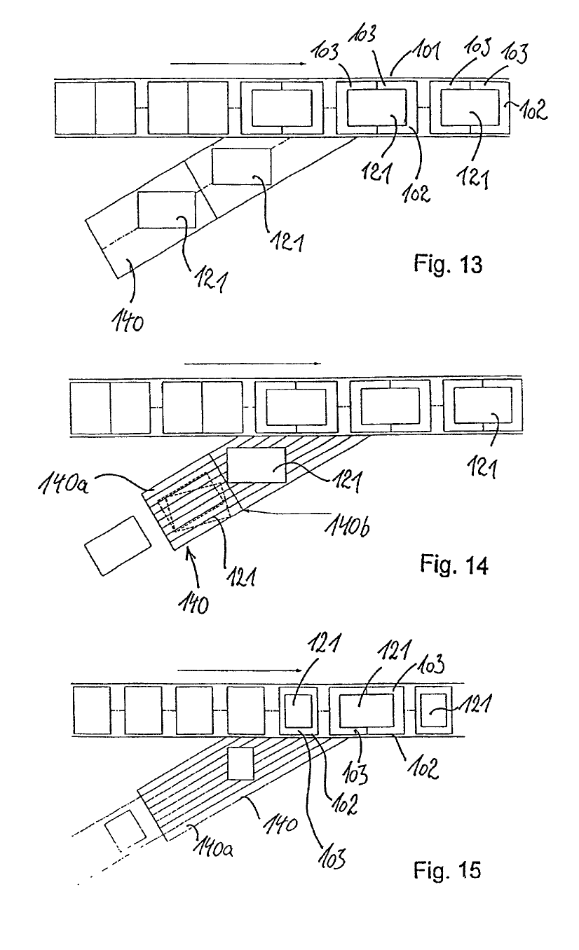

FIG. 13 is a schematic illustration of a part of a conveyor system 101 with a loading conveyor 140 adapted to load each article 121 onto two or more contiguous cross-belts 103 while maintaining the orientation of the articles 121. The loading conveyor 140 of FIG. 14 is divided into a plurality of parallel belts 140a which may be operated at different speeds so as to rotate or re-orient articles 121 prior to loading them onto the cross-belts 103 of the conveyor units 102. A control line 140b is provided. At the control line 140b, it may detected whether an article 121 has been properly re-oriented.

FIG. 15 shows a configuration similar to the configuration of FIG. 14, wherein only one out of a given number of conveyor units 102 is provided with two cross-belts 103. The remaining conveyor units 102 are provided with a single cross-belt 103.

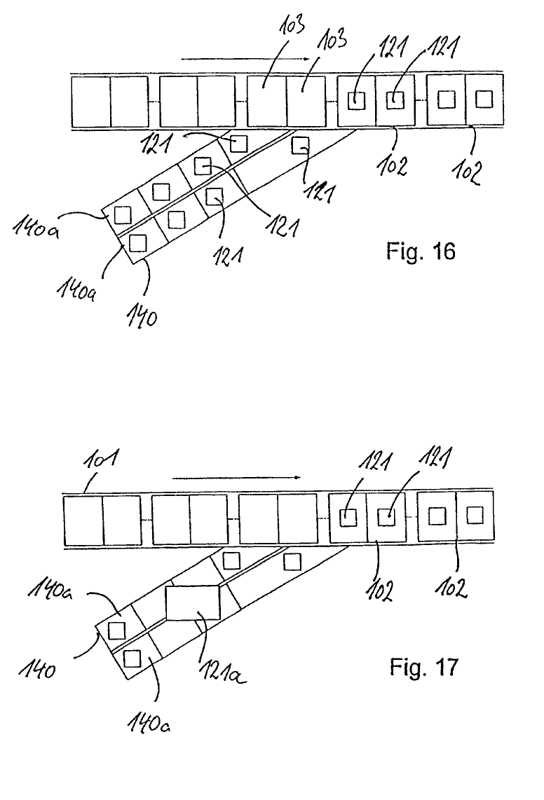

FIG. 16 shows a configuration in which the loading conveyor 140 is divided into two co-extending parts 140a for simultaneously loading two articles onto two contiguous cross-belts 103. FIG. 17 illustrates that the configuration of FIG. 16 may also be adapted to load a relatively large article 121a onto the conveyor 101, the article 121a being conveyed along two belts 140a prior to being loaded onto the conveyor 101.

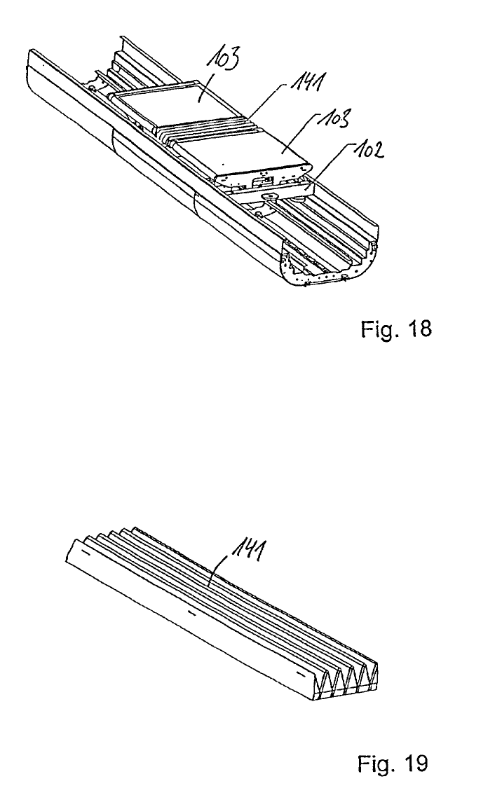

FIG. 18 shows a part of a conveyor system, wherein a space between two contiguous conveyor units 102 is covered by a flexible body 141. FIG. 19 shows the flexible body 141 in detail. The flexible body 141 is preferably made from a rubber material, such as latex. The flexible body 141 may prevent goods from being clamped between two conveyor units 102, e.g., when the conveyor units pass through a curved path. Moreover, the flexible body 141 prevents parts of an article or a part of an article, e.g., a strap of a piece of luggage from being catched by a part of the conveyor unit 102 when unloading the article.

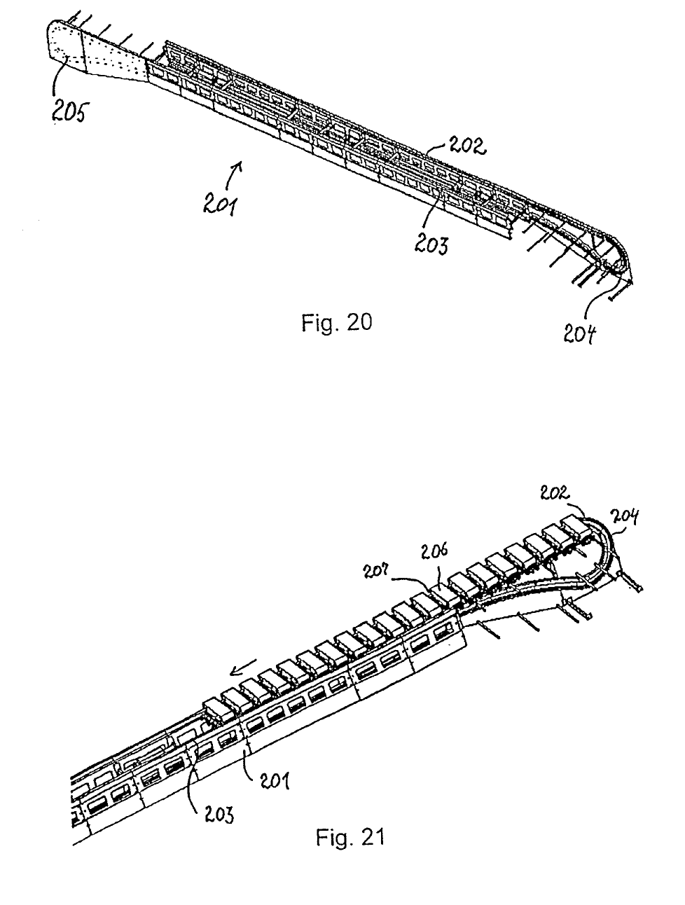

FIG. 20 is a perspective view of a track section 201 of a conveyor according to the invention. The track section 201 comprises a right-hand track section 202 and a left-hand track section 203 and two turns 204 and 205. FIG. 21 is a partly view of a conveyor according to the invention comprising the track section 201 of FIG. 20 with a plurality units 206 for running along the track section 201. At the turn 204, only the right-hand track section 202 is shown. However, it should be understood that also the right-hand track section 203 extends along the turn 204.

In FIGS. 21-25, arrows indicate the conveying direction of the conveyor and the conveyor units.

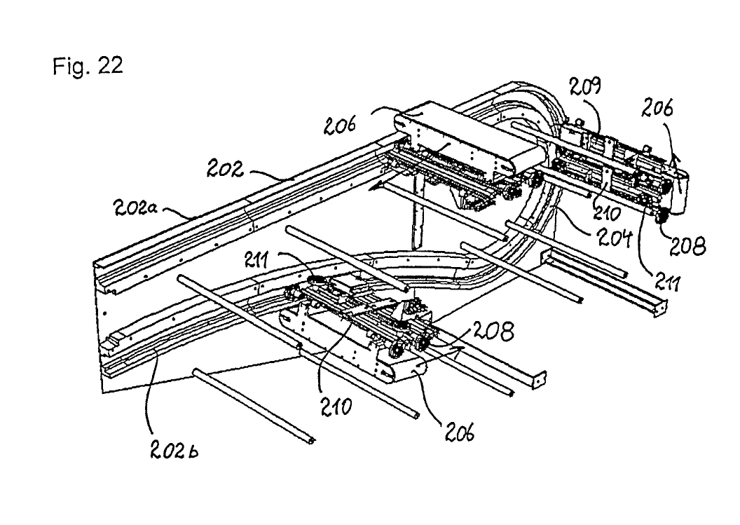

FIG. 22 shows a detail of the turn 204 with three cross-belt units 206 at different location in the turn and on either side of the turn. The right-hand track section 202 comprises an upper run 202a and a lower run 202b interconnected by the turn 204. The cross-belt-units comprise wheels or rollers 208 for rolling along the track left- and right-hand track sections 202 and 203, and frame parts 209 onto having a metallic member 210 for interacting with linear induction motors placed along the sorter (not shown). The cross-belt units further comprise lateral guide rollers 211 for rolling on a side surface of the track sections 202 and 203, so as to stabilise the conveyor in a transverse direction.

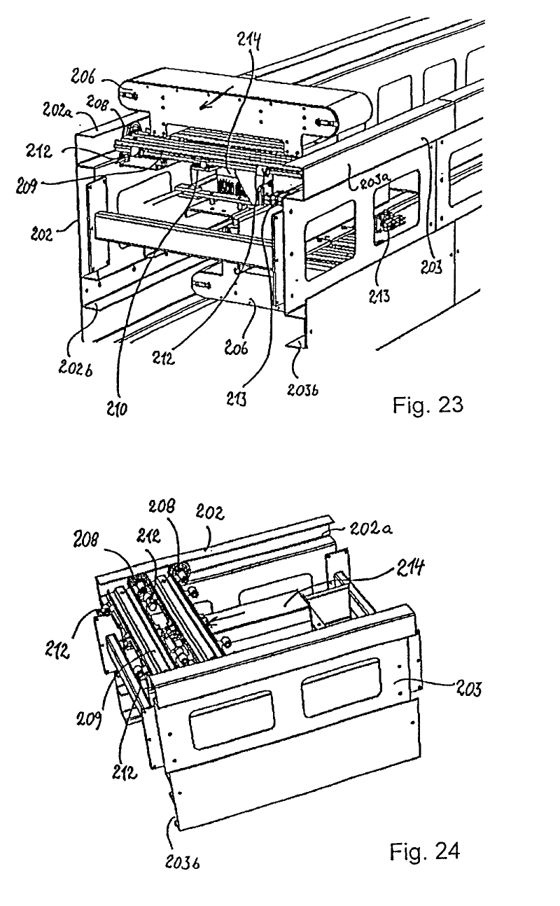

FIG. 23 shows a detail the track section of FIGS. 20 and 21 with a cross-belt unit 206. The left-hand track section 203 comprises an upper run 203a and a lower run 203b. The frame parts 209 of the cross-belt unit 206 comprise coupling means 212 for pivotally interconnecting the cross-belt unit with a neighbouring frame part (not shown) around a substantially horizontal axis. The neighbouring frame part may, e.g., support a cross-belt unit. A pair of power pick-up shoes is mounted to each of the cross-belt unit 206 for picking up power from one or more power conduction rails (not shown) in order to provide power for driving the cross-belts of the cross-belt units 206. A linear induction motor 214 is provided for driving the conveyor along the track sections. The linear induction motor interacts with the metallic member 210 provided at the bottom surface of each of the conveyor units. FIG. 24 shows a detail of a track section with frames 209 for carrying a cross-belt unit.

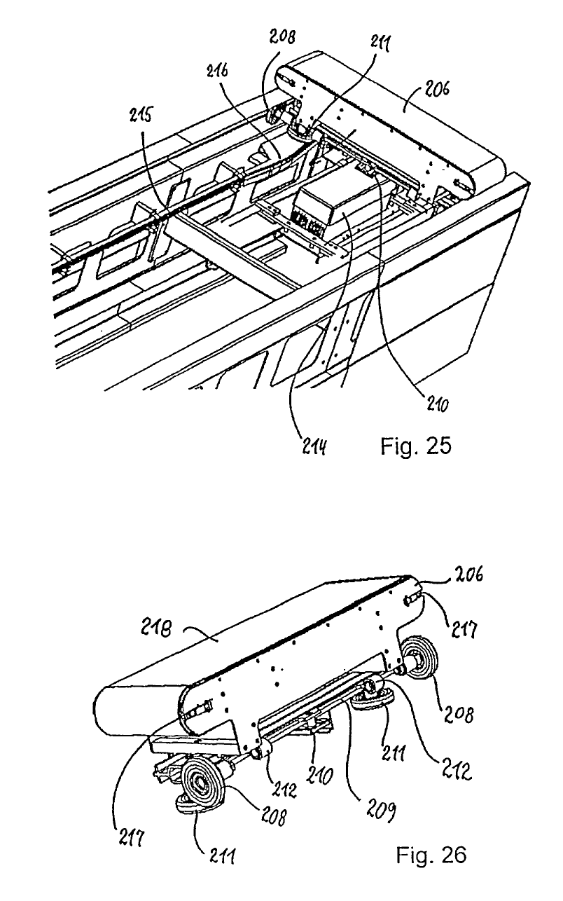

FIG. 25 shows a detail of a track section with power rails 215 for conduction current from which power can be picked up by the cross-belt unit 206 by the pick-up shoes 213 shown in FIG. 23. A guiding member 216 is provided for guiding the pick-up shoes 213 into engagement with the power-conduction rail 215.

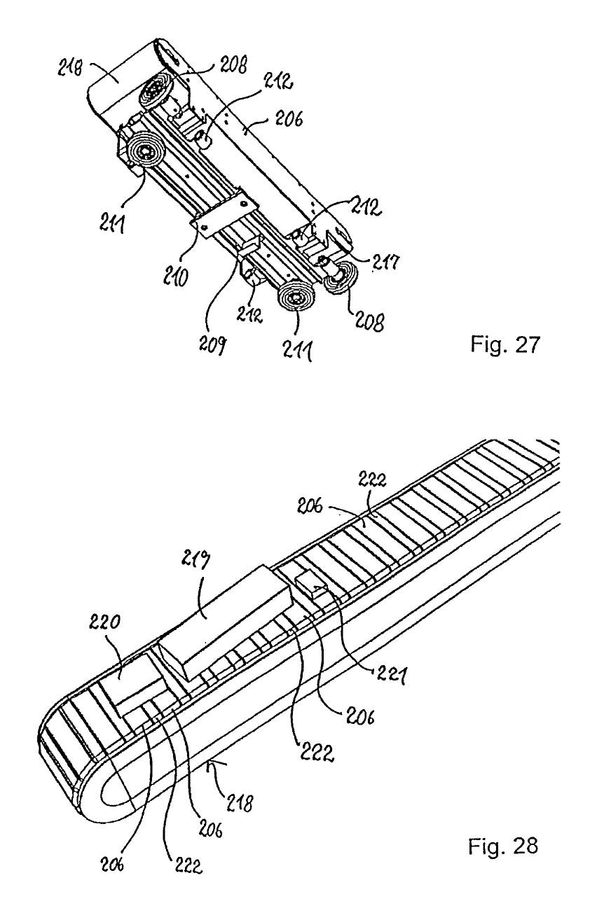

FIGS. 26 and 27 are perspective views from different angle of a cross-belt unit 206. The cross-belt units comprises rollers 217 around which a belt 218 is driven by a motor (not shown).

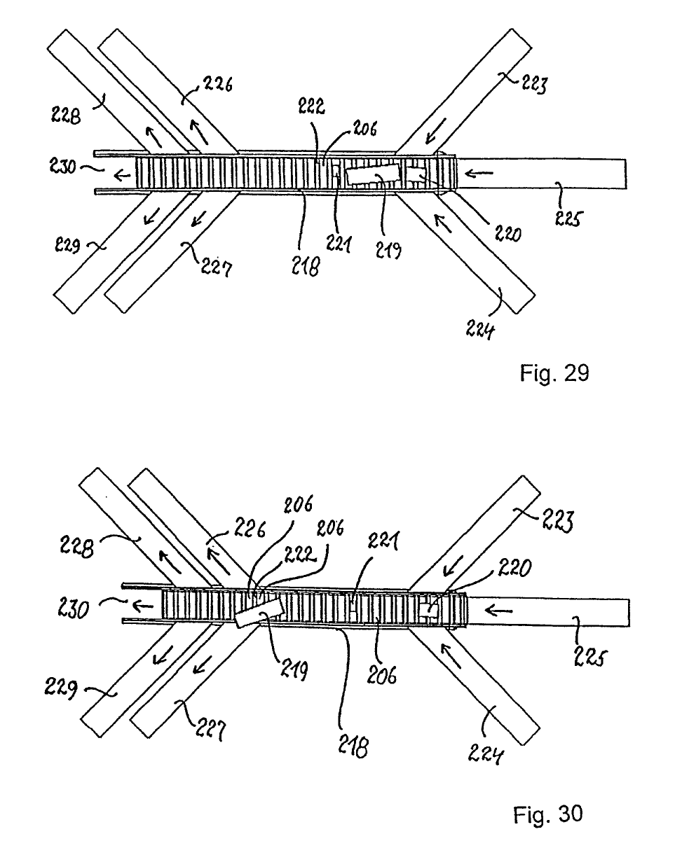

FIG. 28 is a schematic top view of a conveyor 222 accommodating articles 219, 220 and 221, the articles having different lengths in the conveying direction of the conveyor. The smallest of the articles 221 is supported by a single cross-belt unit. The mid-size article 220 is supported by two cross-belt units 206 and a passive surface part 222. The largest article 219 is supported by five cross-belts and four passive surface parts. FIG. 29 is a schematic illustration of the conveyor 218 with loading stations having loading conveyors 223 and 224 which are at an acute angle in relation to the conveyor 218 and a loading conveyor 225 which is substantially parallel to the conveyor 218. Unloading stations having unloading conveyors 226, 227, 228 and 229 which are at an acute angle in relation to the conveyor 218 are provided for receiving articles 219, 220 and 221 being discharged from the conveyor 218 and possibly for transferring articles onto further conveyors. One or more of the unloading conveyors 226, 227, 228 and 229 may be or may comprise conveyors running in a vertical plane, e.g., conveyors of the type shown in FIGS. 20-28. An unloading station 230 for receiving articles and conveying them further in a direction substantially parallel to the conveying direction of the conveyor 218 is provided. The unloading conveyor 230 may be or may comprise a conveyor running in a vertical plane, e.g., the conveyor shown in FIGS. 20-28. FIG. 30 shows the conveyor 218 of FIG. 29, wherein the cross-belt units 206 supporting the article 219 are operated in such a manner as to rotate the article 219 and discharge it onto the discharge conveyor 227 for further conveyance therealong. The discharge conveyor 227 may co-operate with the cross-belt units 206 to rotate the article 209, and the different surface friction coefficients of the passive surface 222 and the cross-belt units 206 may also contribute to rotate the article 219.

In FIGS. 29-32, arrows indicate the conveying direction of the conveyor, the induction and unloading conveyors and the conveyor units.

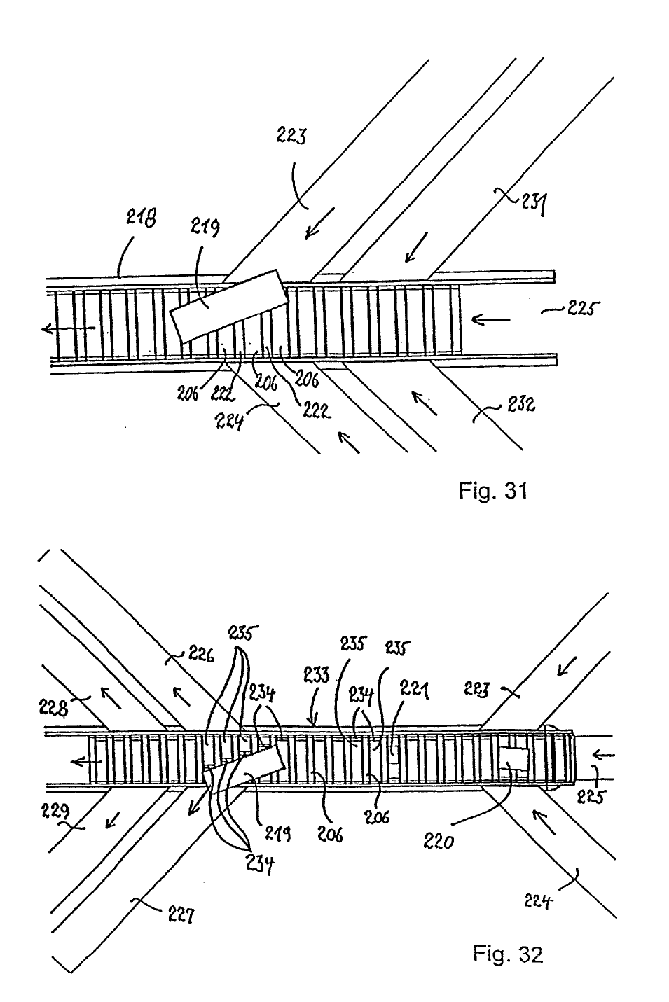

FIG. 31 shows the conveyor 218 of FIGS. 29 and 30, wherein the cross-belt units 206 supporting the article 219 are operated in such a manner as to rotate the article 219 and load it from the induction conveyor 223. The induction conveyor 223 may co-operate with the cross-belt units 206 to rotate the article 209, and the different surface friction coefficients of the passive surface 222 and the cross-belt units 206 may also contribute to rotate the article 219.

FIG. 32 is a schematic illustration of a conveyor 233 having pushers 234 for discharging articles from the conveyor. The pushers 234 are arranged in interstices 235 between the cross-belt units 206 and may engage a side portion of the article 219 so as to assist in discharging the article and force it onto the unloading conveyor 227. When initiating unloading, a pusher at the front end of the article 219 may be activated at an earlier time instant than a pusher at the rear end of the article 219. Thus, the pushers may be operated so as to rotate the article 219 at the discharge station comprising the unloading conveyor 227. The pushers 234 may also be operated so as to rotate an article 219, 220 or 221 while the article is being conveyed along the conveyor 233 between one of the induction conveyors 223, 224, 225. The control system of the conveyor 233 may be adapted to cause repositioning of the pushers 234 at a downstream end of the upper run of the conveyor 233 or at any location along the lower run of the conveyor 233. The number of pushers 234 placed in one side or the other may correspond to the length of the article which will have to be unloaded by the pushers. The side to which the pushers 234 are moved is the opposite side as to which the article is to discharged. The conveyor 233 of FIG. 32 may be of the same kind as and comprise the features of the conveyor illustrated in FIGS. 20-31, the conveyor being further equipped with the pushers 234.

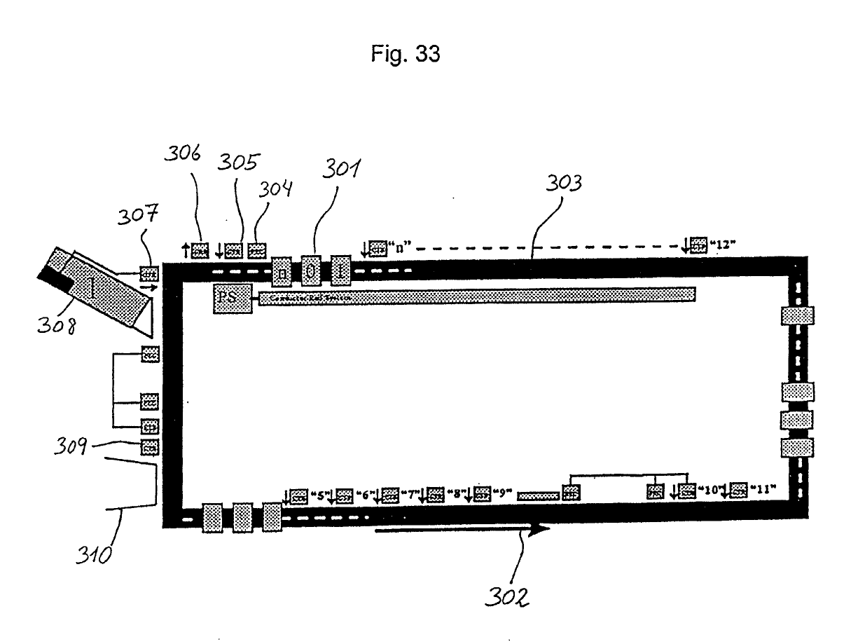

A method according to the invention for loading and unloading an article will be described below, with reference to FIGS. 33-36.

In FIG. 33 a conveyor unit 301 is conveyed with a given velocity in a transport direction 302 along a conveying path 303. The conveyor unit passes a photo cell 304 which senses that the conveyor unit is not occupied by an article. The central control system (not shown) receives a signal from the photo cell indicating that the conveyor unit is free for receiving an article on its supporting unit. The conveyor unit 301 is conveyed further on and passes a first infrared transmitter 305 which transmits a signal from the central control system to the distributed control system (not shown) being positioned on the conveyor unit, the signal indicating the given velocity of the conveyor unit. The microprocessor (not shown) of the distributed control system then chooses, from a table, a predetermined ramp for acceleration, velocity and deceleration of the driving means for loading the article. Subsequently, the conveyor unit is conveyed further on along the conveying path and passes a first infrared receiver 306. When passing said first infrared receiver 306, the distributed control system communicates a signal to the central control system indicating that the status of the driving means is ok, so that the conveyor unit is prepared to receive an article. The conveyor is conveyed further on to a second infrared transmitter 307, and when passing said second infrared transmitter, the central control system communicates a signal, via said second infrared transmitter, indicating the delay time and/or the weight of the article to be loaded and/or the position of the article on the loading station. The delay time is the time that elapses between the moment where the distributed control system receives said signal and the moment where the driving means are to be activated, so as to receive the article at the loading station allocated to the conveyor unit, and so as to obtain a precise loading of the article.

The conveyor unit is conveyed further on to the loading station 308, and the driving means are activated, after said delay time has elapsed, by signals from the distributed control system, so that the acceleration, velocity and deceleration of the driving means follows the predetermined ramp for acceleration, velocity and deceleration of the driving means for loading the article. When the conveyor unit passes the infrared transmitter 310, the central control system communicates a signal, via said infrared transmitter 310, indicating if the article is to be unloaded to the left or to the right side of the conveyor unit. Additionally, the signal may indicate a delay time for activating the driving means for unloading the article.

The conveyor unit is conveyed further on to the unloading station 311 allocated for the article, and the driving means are activated, e.g., after said delay time has elapsed, by signals from the distributed control system, so that the acceleration, velocity and deceleration follows the predetermined ramp for acceleration, velocity and deceleration of the driving means for unloading the article.

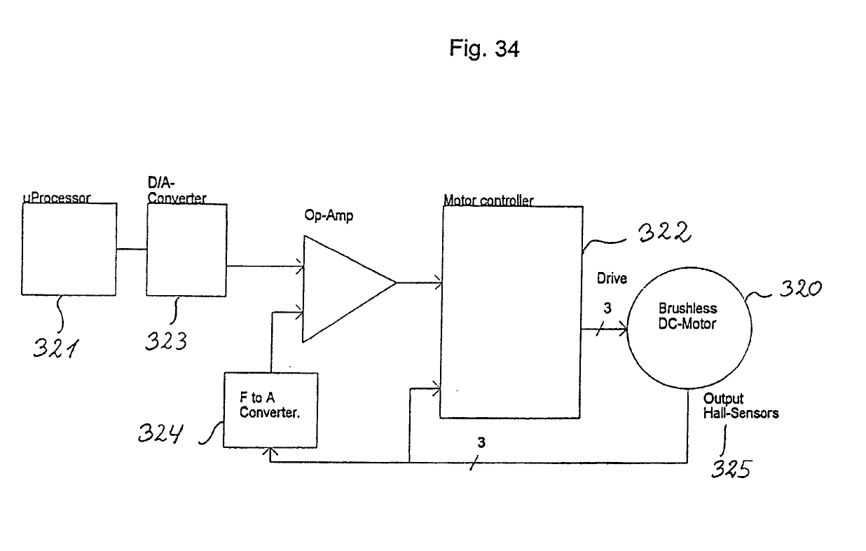

FIG. 34 shows a preferred embodiment of the distributed control system and the driving means. The driving means comprise a brushless DC motor 320 being positioned on each of the conveyor units (not shown), so as to drive the cross-belts (not shown) in a transverse direction to the transport direction of the conveyor units when loading and unloading the one or more articles.

The distributed control system comprises a microprocessor 321, a motor controller 322, a D/A converter 323 for converting digital values to analogous values, and a F/A converter 324 for converting the frequency signals from the Hall sensors 325 to analogous voltage which is proportional to the velocity of the DC motor.

Prior to loading an article, the microprocessor receives a signal indicating the velocity of the conveyor unit. Subsequently, the microprocessor chooses, from a table, a predetermined ramp for acceleration, constant velocity and deceleration of the brushless DC motor 320 when loading and/or unloading the article. Subsequently, the microprocessor receives a signal indicating the delay time for activating the DC motor, and the microprocessor waits for said delay time before it activates the DC motor by sending a digital value to the D/A converter. The D/A converter converts the digital value to an analogous value, said analogous value being transmitted to the motor controller 322. The motor controller drives the DC motor by sending current to the brushless DC motor, so that the motor, according to the predetermined ramp for acceleration, constant velocity and deceleration, accelerates to a constant velocity, keeps the constant velocity for a predetermined time and decelerates to a velocity being zero, when loading the article.

When unloading the article, the microprocessor receives a signal indicating if the article is to be loaded to the left or right side of the conveyor unit and/or a delay time for activating the DC motor. Subsequently, the microprocessor activates the DC motor by sending a digital value to the D/A converter. The D/A converter converts the digital value to an analogous value, said analogous value being transmitted to the motor controller 322. The motor controller drives the DC motor by sending current to the brushless DC motor, so that the motor, according to the predetermined ramp for acceleration, constant velocity and deceleration, accelerates to a constant velocity, keeps the constant velocity for a predetermined time and decelerates to a velocity being zero, when unloading the article.

During acceleration, constant velocity and deceleration, the microprocessor may compare the analogous voltage from the F/A converter with the predetermined ramp for acceleration, velocity and deceleration of the motor when loading and unloading, so as to compensate for any deviation from the predetermined ramp.

The microprocessor has, in addition to the Hall Sensors, three control signals for controlling that the acceleration, velocity and deceleration of the DC motor substantially follows the predetermined ramp. The three signals comprise a first control signal that is inactive when the DC motor is “free”, a second signal indicating the direction of rotation of the DC motor, and a third signal indicating the braking (deceleration) of the DC motor. When the braking signal is activated, two of the windings in the DC motor will be short-circuited, so as to brake the DC motor.

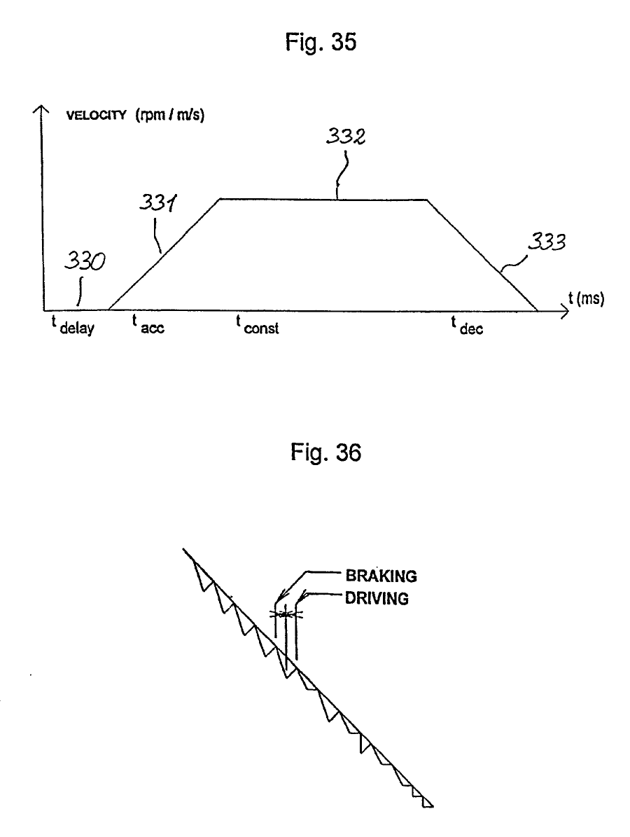

FIG. 35 shows a predetermined ramp for accelerating, keeping a constant velocity and decelerating the driving means. The ramp comprises four sections, a first section 330 indicating the delay time, a second section 331 indicating the acceleration ramp, a third section 332 indicating the constant velocity, and a fourth section 333 indicating the deceleration ramp.

When accelerating and keeping a constant velocity, the controlling of the DC motor is uncomplicated, as said first and second control signals enable a precise controlling of the acceleration and velocity. When decelerating, it may be more complicated, as the microprocessor and motor controller only can drive or brake the DC motor. Therefore, the DC motor has to be controlled by alternate between driving and braking it, so as to ensure that is follows the predetermined ramp for deceleration. An example of such a deceleration ramp is shown in FIG. 36. The frequency for alternate between driving and braking the motor may be between 100 Hz and 700 Hz, but preferably, the frequency is approximately 500 Hz.

1. A conveyor system for conveying and/or sorting articles and comprising:
a plurality of conveyor units adapted to run along a conveyor path,
at least one loading station for loading articles onto the conveyor units,
at least one unloading station for unloading articles,
displacement means for displacing an article in relation to a conveyor unit in a transverse direction in relation to the transport direction of the conveyor units,
at least one of the conveyor units comprising stopping means for stopping the transverse displacement of an article in relation to a conveyor unit.

2. A conveyor unit for a conveyor system for conveying and/or sorting articles, the conveyor unit comprising:
displacement means for displacing an article in relation to a conveyor unit in a transverse direction in relation to the transport direction of the conveyor system,
stopping means for stopping the transverse displacement of an article in relation to a conveyor unit.

3. A conveyor system for conveying and/or sorting articles and comprising:
a plurality of conveyor units adapted to run along a conveyor path,
at least one loading station for loading articles onto the conveyor units,
at least one unloading station for unloading articles,
at least some of the conveyor units comprising at least two cross-belt units forming a substantially continuous supporting surface for one or more articles.

4. A conveyor system for conveying and/or sorting articles and comprising:
a plurality of conveyor units adapted to run along a conveyor path, each conveyor unit comprising a cross-belt unit which is divided into a plurality of belt segments, each belt segment extending in a transverse direction in relation to the transport direction of conveyor units,
at least one loading station for loading articles onto the conveyor units,
at least one unloading station for unloading articles.

5. A conveyor system comprising a plurality of conveyor units adapted to run along a conveyor path, the conveyor system comprising at least one loading station for loading articles onto the conveyor units, the conveyor units comprising cross-belts and cross-belt driving means for driving the cross-belts, the loading station comprising article advancing means for advancing articles in a loading direction which is at an angle in relation to the direction in which the conveyor units move along the conveying path, the article advancing means and the cross-belt driving means being operable in such a way that articles having a length smaller than a predetermined length can be loaded onto a single cross-belt and that articles having a length greater than a predetermined length can be loaded onto two or more contiguous cross-belts, whereby, in case an article is loaded onto tow or more contiguous cross-belts, the article advancing means and the cross-belt driving means are operated in such a way that the orientation of an article is maintained during loading of the article onto the cross-belts.

6. A conveyor system for conveying and/or sorting articles and comprising:
a plurality of conveyor units adapted to run along a conveyor path,
at least one loading station for loading articles onto the conveyor units and comprising a loading conveyor, the loading conveyor comprising a plurality of parallel belts which are operable at different speeds, such that an article may be reoriented or rotated while being conveyed along the loading conveyor,
at least one unloading station for unloading articles.

7. A conveyor system for conveying and/or sorting articles and comprising:
a plurality of conveyor units adapted to run along a conveyor path, each conveyor unit comprising at least one cross-belt unit,
at least one loading station for loading articles onto the conveyor units, the loading station comprising an elevated loading conveyor under which the conveyor units may pass, whereby articles may be loaded from above,
at least one unloading station for unloading articles.

8. A conveyor system for conveying and/or sorting articles and comprising:
a plurality of conveyor units adapted to run along a conveyor path,
at least one loading station for loading articles onto the conveyor units, the loading station comprising a loading conveyor which is adapted to load articles onto the conveyor units in a sideways direction in relation to the transport direction of the conveyor units, the loading conveyor being further adapted to load at least two articles onto a single conveyor unit, so that the at least two articles are being arranged next to each other in a direction transverse to the transport direction of the conveyor units.
at least one unloading station for unloading articles.

9. A method for conveying articles along a conveyor in a conveying direction, the conveyor comprising:
a plurality of conveyor units,
a plurality of cross-belt units for unloading articles in an unloading direction perpendicular to the conveying direction, each cross-belt unit comprising a drive for driving the respective cross-belts in the unloading direction,
a drive for driving the conveyor units in the conveying direction,
at least one loading station for loading articles onto the conveyor,
at least one discharge station for discharging articles from the conveyor,
the method comprising:
(i) loading an article onto a single cross-belt unit in case the article has a length smaller than or equal to the width of the cross-belt unit,
(ii) loading an article onto two or more cross-belt units in case the article has a length greater than the width of a single cross-belt unit,
(iii) conveying the article along the conveyor in the conveying direction,
(iv) discharging the article at a selected discharge station, the step of discharging comprising:
(a) in case the article is loaded onto a single cross-belt unit: activating the cross-belt unit so as to discharge the article in a direction transverse to the conveying direction,
(b) in case the article is loaded onto two or more cross-belt units: activating the two or more cross-belt units, whereby the two or more cross-belt units are accelerated at at least two different rates of acceleration.

10. A conveyor for conveying articles in a conveying direction and comprising:
a plurality of conveyor units,
a plurality of cross-belt units for unloading articles in an unloading direction perpendicular to the conveying direction, each cross-belt unit comprising a drive for driving the respective cross-belts in the unloading direction,
a drive for driving the conveyor units in the conveying direction,
at least one loading station for loading articles onto the conveyor,
at least one discharge station for discharging articles from the conveyor,
a control system for controlling operation of the conveyor, the control system being adapted to control operation of the conveyor, so as to:
(i) load an article onto a single cross-belt unit in case the article has a length smaller than or equal to the width of the cross-belt unit,
(ii) load an article onto two or more cross-belt units in case the article has a length greater than the width of a single cross-belt unit,
(iv) discharge the article at a selected discharge station, the control system being adapted to activate the cross belts in the following manners:
(a) in case the article is loaded onto a single cross-belt unit: activate the cross-belt unit so as to discharge the article in a direction transverse to the conveying direction,
(b) in case the article is loaded onto two or more cross-belt units: activate the two or more cross-belt units, whereby the two or more cross-belt units are accelerated at at least two different rates of acceleration.

11. A method for conveying articles along a conveyor in a conveying direction, the conveyor comprising:
a plurality of conveyor units,
a plurality of cross-belt units for loading and unloading articles in a loading direction perpendicular to the conveying direction, each cross-belt unit comprising a cross-belt drive for driving the respective cross-belts in the loading direction,
a drive for driving the conveyor units in the conveying direction,
at least one loading station for loading articles onto the conveyor,
at least one discharge station for discharging articles from the conveyor,
the method comprising:
(i) loading an article onto a single cross-belt unit in case the article has a length smaller than or equal to the width of the cross-belt unit,
(ii) loading an article onto two or more cross-belt units in case the article has a length greater than the width of a single cross-belt unit,
(iii) conveying the article along the conveyor in the conveying direction,
(iv) discharging the article at a selected discharge station, the step of loading comprising:
(a) in case the article is loaded onto a single cross-belt unit: activating the cross-belt unit so as to load the article onto the cross-belt unit,
(b) in case the article is loaded onto two or more cross-belt units: activating the two or more cross-belt units, whereby the two or more cross-belt units are accelerated at at least two different rates of acceleration.

12. A conveyor for conveying articles in a conveying direction and:
a plurality of conveyor units,
a plurality of cross-belt units for loading and unloading articles in a loading direction perpendicular to the conveying direction, each cross-belt unit comprising a cross-belt drive for driving the respective cross-belts in the loading direction,
a drive for driving the conveyor units in the conveying direction,
at least one loading station for loading articles onto the conveyor,
at least one discharge station for discharging articles from the conveyor,
a control system being adapted to:
(i) load an article onto a single cross-belt unit in case the article has a length smaller than or equal to the width of the cross-belt unit,
(ii) load an article onto two or more cross-belt units in case the article has a length greater than the width of a single cross-belt unit,
(iv) discharge the article at a selected discharge station,
the control system being further adapted to:
(a) in case the article is loaded onto a single cross-belt unit: activate the cross-belt unit so as to load the article onto the cross-belt unit,
(b) in case the article is loaded onto two or more cross-belt units: activate the two or more cross-belt units, whereby the two or more cross-belt units are accelerated at at least two different rates of acceleration.

13. A conveyor system for conveying and/or sorting articles and comprising:
a plurality of conveyor units adapted to run along a conveyor path,
at least one loading station for loading articles onto the conveyor units,
at least one unloading station for unloading articles,
unloading of articles being controllable, so that unloading may be activated at different predetermined locations of the conveyor units in relation to an unloading station, whereby sorting or distribution of articles is achieved at the unloading station while unloading articles.

14. A method of unloading articles from a conveyor system, the method comprising controlling unloading of articles, so that unloading may be activated at different predetermined locations of the conveyor units in relation to an unloading station, whereby sorting of articles is achieved at the unloading station while unloading articles.

15. A conveyor system for conveying and/or sorting articles and comprising:
a plurality of conveyor units adapted to run along a conveyor path,
at least one loading station for loading articles onto the conveyor units,
at least one transfer station for transferring articles to one or more unloading stations,
at least one posterior conveyor onto which articles may be loaded at the transfer station, the posterior conveyor being adapted to sort articles into the one or more unloading stations.

16. A conveyor unit for a conveyor system for conveying and/or sorting articles, the conveyor unit comprising a cross-belt unit which is tiltable, so as to achieve unloading by driving the cross-belt and/or by tilting the cross-belt.

17. A conveyor system for conveying and/or sorting articles and comprising:
a plurality of conveyor units adapted to run along a conveying path in a transport direction, each of the conveyor units comprising:
one or more cross-belts for supporting, loading and/or unloading one or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively, the control system being adapted to:
send an activation signal to the driving means of a particular cross-belt(s) when said particular cross-belt(s) is/are to be activated,
initiate acceleration of said particular cross-belt(s) by means of the driving means after a predetermined delay time, the delay time being the time elapsing between sending of the activation signal and activation of the driving means for accelerating said particular cross-belt(s),
accelerate, according to a predetermined velocity ramp which is a function of at least one predetermined parameter, said particular cross-belt(s) to a predetermined velocity,
keep the predetermined velocity for a predetermined time,
decelerate, according to a predetermined deceleration ramp which is a function of at least one predetermined parameter, said particular cross-belt(s).

18. A conveyor system for conveying and/or sorting articles and comprising:
a plurality of conveyor units adapted to run along a conveying path in a transport direction, each of the conveyor units comprising:
one or more cross-belts for supporting, loading and/or unloading one or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively, the control system being adapted to:
send an activation signal to the driving means of a particular cross-belt(s) when said particular cross-belt(s) is/are to be activated,
initiate acceleration of said particular cross-belt(s) by means of the driving means after a predetermined delay time, the delay time being the time elapsing between sending of the activation signal and activation of the driving means for accelerating said particular cross-belt(s),
accelerate, according to a predetermined velocity ramp which is a function of at least one predetermined parameter, said particular cross-belt(s) to a predetermined velocity,
keep the predetermined velocity for a predetermined time,
decelerate said particular cross-belt(s).

19. A conveyor system for conveying and/or sorting articles and comprising:
a plurality of conveyor units adapted to run along a conveying path in a transport direction, each of the conveyor units comprising:
one or more cross-belts for supporting, loading or unloading the one and/or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively, the control system being adapted to:
send an activation signal to the driving means of a particular cross-belt(s) when said particular cross-belt(s) is/are to be activated,
initiate acceleration of said particular cross-belt(s) by means of the driving means after a predetermined delay time, the delay time being the time elapsing between sending of the activation signal and activation of the driving means for accelerating said particular cross-belt(s),
accelerate said particular cross-belt(s) to a predetermined velocity,
keep the predetermined velocity for a predetermined time,
decelerate, according to a predetermined deceleration ramp which is a function of at least one predetermined parameter, said particular cross-belt(s) to a predetermined velocity.

20. A method for loading articles onto a conveyor unit in a conveyor system comprising:
a plurality of conveyor units adapted to run along a conveying path in a transport direction, each of the conveyor units comprising:
one or more cross-belts for supporting, loading and/or unloading one or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively,
the method comprising:
sending an activation signal to the driving means of a particular cross-belt(s) when said particular cross-belt(s) is/are to be activated,
initiating acceleration of said particular cross-belt(s) by means of the driving means after a predetermined delay time, the delay time being the time elapsing between sending of the activation signal and activation of the driving means for accelerating said particular cross-belt(s),
accelerating, according to a predetermined velocity ramp which is a function of at least one predetermined parameter, said particular cross-belt(s) to a predetermined velocity,
keeping the predetermined velocity for a predetermined time,
decelerating, according to a predetermined deceleration ramp which is a function of at least one predetermined parameter, said particular cross-belt(s).

21. A method for loading articles onto a conveyor unit in a conveyor system comprising:
a plurality of conveyor units adapted to run along a conveying path in a transport direction, each of the conveyor units comprising:
one or more cross-belts for supporting, loading and/or unloading one or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively,
the method comprising:
sending an activation signal to the driving means of a particular cross-belt(s) when said particular cross-belt(s) is/are to be activated,
initiating acceleration of said particular cross-belt(s) by means of the driving means after a predetermined delay time, the delay time being the time elapsing between sending of the activation signal and activation of the driving means for accelerating said particular cross-belt(s),
accelerating, according to a predetermined velocity ramp which is a function of at least one predetermined parameter, said particular cross-belt(s) to a predetermined velocity,
keeping the predetermined velocity for a predetermined time,
decelerating said particular cross-belt(s).

22. A method for loading articles onto a conveyor unit in a conveyor system comprising:
a plurality of conveyor units adapted to run along a conveying path in a transport direction, each of the conveyor units comprising:
one or more cross-belts for supporting, loading or unloading the one and/or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively,
the method comprising:
send an activation signal to the driving means of a particular cross-belt(s) when said particular cross-belt(s) is/are to be activated,
initiate acceleration of said particular cross-belt(s) by means of the driving means after a predetermined delay time, the delay time being the tie elapsing between sending of the activation signal and activation of the driving means for accelerating said particular cross-belt(s),
accelerate said particular cross-belt(s) to a predetermined velocity,
keep the predetermined velocity for a predetermined time,
decelerate, according to a predetermined deceleration ramp which is a function of at least one predetermined parameter, said particular cross-belt(s) to a predetermined velocity.

23. A method for unloading articles from a conveyor unit in a conveyor system comprising:
a plurality of conveyor units adapted to run along a conveying path in a transport direction, each of the conveyor units comprising:
one or more cross-belts for supporting, loading and/or unloading one or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively,
the method comprising:
sending an activation signal to the driving means of a particular cross-belt(s) when said particular cross-belt(s) is/are to be activated,
initiating acceleration of said particular cross-belt(s) by means of the driving means after a predetermined delay time, the delay time being the time elapsing between sending of the activation signal and activation of the driving means for accelerating said particular cross-belt(s),
accelerating, according to a predetermined velocity ramp which is a function of at least one predetermined parameter, said particular cross-belt(s) to a predetermined velocity,
keeping the predetermined velocity for a predetermined time,
decelerating, according to a predetermined deceleration ramp which is a function of at least one predetermined parameter, said particular cross-belt(s).

24. A method for unloading articles from a conveyor unit in a conveyor system comprising:
a plurality of conveyor units adapted to run along a conveying path in a transport direction, each of the conveyor units comprising:
one or more cross-belts for supporting, loading and/or unloading one or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively,
the method comprising:
sending an activation signal to the driving means of a particular cross-belt(s) when said particular cross-belt(s) is/are to be activated,
initiating acceleration of said particular cross-belt(s) by means of the driving means after a predetermined delay time, the delay time being the time elapsing between sending of the activation signal and activation of the driving means for accelerating said particular cross-belt(s),
accelerating, according to a predetermined velocity ramp which is a function of at least one predetermined parameter, said particular cross-belt(s) to a predetermined velocity,
keeping the predetermined velocity for a predetermined time,
decelerating said particular cross-belt(s).

25. A method for unloading articles from a conveyor unit in a conveyor system comprising:
a plurality of conveyor units adapted to run along a conveying path in a transport direction, each of the conveyor units comprising:
one or more cross-belts for supporting, loading or unloading the one and/or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively,
the method comprising:
sending an activation signal to the driving means of a particular cross-belt(s) when said particular cross-belt(s) is/are to be activated,
initiating acceleration of said particular cross-belt(s) by means of the driving means after a predetermined delay time, the delay time being the tie elapsing between sending of the activation signal and activation of the driving means for accelerating said particular cross-belt(s),
accelerating said particular cross-belt(s) to a predetermined velocity,
keeping the predetermined velocity for a predetermined time,
decelerating, according to a predetermined deceleration ramp which is a function of at least one predetermined parameter, said particular cross-belt(s) to a predetermined velocity.

26. A method for conveying articles in a conveyor system comprising:
a plurality of conveyor units adapted to run along a conveying path in a transport direction, each of the conveyor units comprising:
one or more cross-belts for supporting, loading and/or unloading one or more articles,
driving means for driving the cross-belt(s) in a direction transverse to said transport direction,
at least one loading station for loading articles onto the conveyor units,
at least one unloading station for receiving articles being unloaded from the conveyor units,
a control system for controlling the driving means, so as to load or unload the one or more articles at the loading or unloading stations, respectively,
the method comprising:
loading an article onto one or more conveyor units of the conveyor system,
conveying said article along the conveyor system,
unloading said article from said one or more conveyor units.

27. A conveyor for conveying and sorting articles and comprising:
a plurality of conveyor units having means for carrying articles, the conveyor units being coupled together to form an endless loop in a vertical plane, wherein the endless loop comprises a part along which an upper and a lower run have a substantially parallel course at a vertical distance from each other, and two loop turning parts, each of which has a curved configuration for interconnecting the upper and the lower run, the diameter of the curve being larger than the vertical distance between the substantially parallel upper and lower rails,
means for driving the conveyor units along the closed loop.

28. A conveyor system for conveying and sorting articles and comprising at least a first and a second conveyor, each of which comprises:
a plurality of conveyor units having means for carrying articles, the conveyor units being coupled together to form an endless loop in a vertical plane, wherein the endless loop comprises a part along which an upper and a lower run have a substantially parallel course at a vertical distance from each other, and two loop turning parts, each of which has a curved configuration for interconnecting the upper and the lower run,
means for driving the conveyor units long the closed loop,
at least one discharge station for receiving articles being discharged from each of the first and second conveyor, respectively,
the conveyor system further comprising at least one induction conveyor for feeding articles onto the upper run of the first conveyor, at least one of the at least one discharge stations of the first conveyor being connected to an induction of the second conveyor.

29. A method for conveying and sorting articles in a conveyor system which comprises at least a first and a second conveyor, each of which comprises:
a plurality of conveyor units having means for carrying articles, the conveyor units being coupled together to form an endless loop in a vertical plane, wherein the endless loop comprises a part along which an upper and a lower run have a substantially parallel course at a vertical distance from each other, and two loop turning parts, each of which has a curved configuration for interconnecting the upper and the lower run,
means for driving the conveyor units long the closed loop,
at least one discharge station for receiving articles being discharged from each of the first and second conveyor, respectively,
the conveyor system further comprising at least one induction conveyor for feeding articles onto the upper run of the first conveyor, at least one of the at least one discharge stations of the first conveyor being connected to an induction of the second conveyor, the method comprising the steps of:
(a) feeding an article onto the first conveyor,
(b) conveying the article along the first conveyor to a discharge station of the first conveyor,
(c) discharging the article at the discharge station of the first conveyor,
(d) transferring the article from the discharge station of the first conveyor to the second conveyor, and feeding the article onto the second conveyor,
(e) conveying the article along the second conveyor to a discharge station of the second conveyor,
(f) discharging the article at the discharge station.

30. A conveyor for conveying and sorting articles and comprising:
a plurality of conveyor units having cross-belts for carrying articles, the conveyor units being coupled together to form an endless loop,
one or more drive means for driving the conveyor units,
the cross-belts being arranged at distances from each other in the direction of movement of the conveyor, at least some of the interstices thereby formed being provided with passive surface parts having a friction coefficient which is different from the friction coefficient of the carrying surfaces of the cross-belts.

31. A conveyor for conveying and sorting articles and comprising:
a plurality of conveying units having cross-belts for carrying articles, the conveyor units being coupled together to form an endless loop,
one or more drive means for driving the conveyor units in a conveying direction,
at least one loading stations at which articles can be loaded onto the conveyor,
at least one discharge station at which articles can be discharged from the conveyor,
the cross-belts being arranged at distances from each other in the direction of movement of the conveyor,
interstices between the cross-belts,
pushers provided in at least some of the interstices for engaging a side portion of an article when discharging the article at the discharge station,
means for moving the pushers in a direction substantially perpendicular to the surface of the cross-belts between a projecting position in which the pushers project from the surface of the cross-belts in the interstices and a recessed position in the interstices,
means for moving the pushers back and forth in the interstices,
a control system for controlling the movement of the pushers and other operations of the conveyor.

32. A method of conveying and sorting articles in a conveyor comprising:
a plurality of conveying units having cross-belts for carrying articles, the conveyor units being coupled together to form an endless loop,
one or more drive means for driving the conveyor units in a conveying direction,
at least one loading stations at which articles can be loaded onto the conveyor,
at least one discharge station at which articles can be discharged from the conveyor,
the cross-belts being arranged at distances from each other in the direction of movement of the conveyor,
interstices between the cross-belts,
pushers provided in at least some of the interstices for engaging a side portion of an article when discharging the article at the discharge station,
means for moving the pushers in a direction substantially perpendicular to the surface of the cross-belts between a projecting position in which the pushers project from the surface of the cross-belts in the interstices and a recessed position in the interstices,
means for moving the pushers back and forth in the interstices,
a control system for controlling the movement of the pushers and other operations of the conveyor,
the method comprising:
(a) loading an article onto the conveyor at the loading station,
(b) conveying the article to a discharge station,
(c) activating the cross belt or belts which support the article at a discharge station, so as to discharge the article.

33. A conveyor for conveying and sorting articles and comprising:
a plurality of conveying units for carrying articles, the conveyor units being coupled together to form an endless loop, each conveying unit having an upper side and a bottom side,
one or more drive means for driving the conveyor units in a conveying direction,
at least one loading stations at which articles can be loaded onto the conveyor,
at least one discharge station at which articles can be discharged from the conveyor,
the conveying units being arranged at distances from each other in the direction of movement of the conveyor,
interstices between the conveying units,
pushers provided in at least some of the interstices for engaging a side portion of an article when discharging the article at the discharge station,
pusher moving means for moving the pushers in the interstices in a first direction transverse to the conveying direction, the pusher moving means being adapted to:
move the pushers between a projecting position in which they project from the surface of the conveying units and a recessed position in the interstices,
move the pushers in said first transverse direction when the pushers are in the projecting position,
move the pushers in a second transverse direction opposite to the first transverse direction when the pushers are in the recessed position,
a control system for controlling the movement of the pushers and other operations of the conveyor.

34. A method of conveying and sorting articles in a conveyor comprising:
a plurality of conveying units for carrying articles, the conveyor units being coupled together to form an endless loop, each conveying unit having an upper side and a bottom side,
one or more drive means for driving the conveyor units in a conveying direction,
at least one loading stations at which articles can be loaded onto the conveyor,
at least one discharge station at which articles can be discharged from the conveyor,
the conveying units being arranged at distances from each other in the direction of movement of the conveyor,
interstices between the conveying units,
pushers provided in at least some of the interstices for engaging a side portion of an article when discharging the article at the discharge station,
pusher moving means for moving the pushers in the interstices in a first direction transverse to the conveying direction, between a right-hand and a left-hand side of the conveyor and vice versa, the pusher moving means being adapted to:
move the pushers between a projecting position in which they project from the surface of the conveying units and a recessed position in the interstices,
move the pushers in said first transverse direction when the pushers are in the projecting position,
move the pushers in a second transverse direction opposite to the first transverse direction when the pushers are in the recessed position,
the method comprising:
(a) loading an article onto the conveyor at the loading station,
(b) conveying the article to a discharge station,
(c) activating at least one pusher at a discharge station, so as to discharge the article, whereby the at least one pusher engages a side portion of the article, so as to thereby impose a pushing force on the article.
